(19) United States
(12) Patent Application Publication
(10) Pub. No.: US 2010/0141211 A1
(43) Pub. Date: Jun. 10, 2010

(54) HYBRID ELECTROCHEMICAL GENERATOR WITH A SOLUBLE ANODE

(76) Inventor: Rachid YAZAMI, Los Angeles, CA (US)

Correspondence Address: GREENLEE WINNER AND SULLIVAN P C, 4875 PEARL EAST CIRCLE, SUITE 200, BOULDER, CO, 80301, US

(21) Appl. No.: 12/612,409

(22) Filed: Nov. 4, 2009

Related U.S. Application Data
(60) Provisional application No. 61/198,237, filed on Nov. 4, 2008.
(60) Provisional application No. 61/247,882, filed on Oct. 1, 2009.

(51) Int. Cl. H01M 4/36; H02J 7/00

(52) U.S. Cl. 320/127; 252/182.1; 429/105; 320/137

(57) ABSTRACT

The invention relates to soluble electrodes, including soluble anodes, for use in electrochemical systems, such as electrochemical generators including primary and secondary batteries and fuel cells. Soluble electrodes of the invention are capable of effective replenishing and/or regeneration, and thereby enable an innovative class of electrochemical systems capable of efficient recharging and/or electrochemical cycling. In addition, soluble electrodes of the invention provide electrochemical generators combining high energy density and enhanced safety with respect to conventional lithium ion battery technology. In some embodiments, for example, the invention provides a soluble electrode comprising an electron donor metal and electron acceptor provided in a solvent so as to generate a solvated electron solution capable of participating in oxidation and reduction reactions useful for the storage and generation of electrical current.

### CROSS REFERENCE TO RELATED APPLICATIONS

This application claims the benefit of U.S. Provisional Application No. 61/198,237, filed Nov. 4, 2008 and U.S. Provisional Application No. 61/247,882, filed Oct. 1, 2009, which are each hereby incorporated by reference in their entireties to the extent not inconsistent with the present description.

### BACKGROUND

Over the last few decades revolutionary advances have been made in electrochemical storage and conversion devices expanding the capabilities of these systems in a variety of fields including portable electronic devices, air and space craft technologies, and biomedical instrumentation. Current state of the art electrochemical storage and conversion devices have designs and performance attributes that are specifically engineered to provide compatibility with a diverse range of application requirements and operating environments. For example, advanced electrochemical storage systems have been developed spanning the range from high energy density batteries exhibiting very low self discharge rates and high discharge reliability for implanted medical devices to inexpensive, light weight rechargeable batteries providing long runtimes for a wide range of portable electronic devices to high capacity batteries for military and aerospace applications capable of providing extremely high discharge rates over short time periods.

Despite the development and widespread adoption of this diverse suite of advanced electrochemical storage and conversion systems, significant pressure continues to stimulate research to expand the functionality of these systems, thereby enabling an even wider range of device applications. Large growth in the demand for high power portable electronic products, for example, has created enormous interest in developing safe, light weight primary and secondary batteries providing higher energy densities. In addition, the demand for miniaturization in the field of consumer electronics and instrumentation continues to stimulate research into novel design and material strategies for reducing the sizes, masses and form factors of high performance batteries. Further, continued development in the fields of electric vehicles and aerospace engineering has also created a need for mechanically robust, high reliability, high energy density and high power density batteries capable of good device performance in a useful range of operating environments.

Many recent advances in electrochemical storage and conversion technology are directly attributable to discovery and integration of new materials for battery components. Lithium battery technology, for example, continues to rapidly develop, at least in part, due to the discovery of novel electrode and electrolyte materials for these systems. From the pioneering discovery and optimization of intercalation host materials for positive electrodes, such as fluorinated carbon materials and nanostructured transition metal oxides, to the development of high performance non-aqueous electrolytes, the implementation of novel materials strategies for lithium battery systems have revolutionized their design and performance capabilities. Furthermore, development of intercalation host materials for negative electrodes has led to the discovery and commercial implementation of lithium ion based secondary batteries exhibiting high capacity, good stability and useful cycle life. As a result of these advances, lithium based battery technology is currently widely adopted for use in a range of important applications including primary and secondary electrochemical cells for portable electronic systems.

Commercial primary lithium battery systems typically utilize a lithium metal negative electrode for generating lithium ions which during discharge are transported through a liquid phase or solid phase electrolyte and undergo intercalation reaction at a positive electrode comprising an intercalation host material. Dual intercalation lithium ion secondary batteries have also been developed, wherein lithium metal is replaced with a lithium ion intercalation host material for the negative electrode, such as carbons (e.g., graphite, cokes etc.), metal oxides, metal nitrides and metal phosphides. Simultaneous lithium ion insertion and de-insertion reactions allow lithium ions to migrate between the positive and negative intercalation electrodes during discharge and charging. Incorporation of a lithium ion intercalation host material for the negative electrode has the significant advantage of avoiding the use of metallic lithium which is susceptible to safety problems upon recharging attributable to the highly reactive nature and non-epitaxial deposition properties of lithium.

The element lithium has a unique combination of properties that make it attractive for use in an electrochemical cell. First, it is the lightest metal in the periodic table having an atomic mass of 6.94 AMU. Second, lithium has a very low electrochemical oxidation/reduction potential, i.e., −3.045 V vs. NHE (normal hydrogen reference electrode). This unique combination of properties enables lithium based electrochemical cells to have very high specific capacities. Advances in materials strategies and electrochemical cell designs for lithium battery technology have realized electrochemical cells capable of providing useful device performance including: (i) high cell voltages (e.g. up to about 3.8 V), (ii) substantially constant (e.g., flat) discharge profiles, (iii) long shelf-life (e.g., up to 10 years), and (iv) compatibility with a range of operating temperatures (e.g., −20 to 60 degrees Celsius). As a result of these beneficial characteristics, primary lithium batteries are widely used as power sources in a range of portable electronic devices and in other important device applications including, electronics, information technology, communication, biomedical engineering, sensing, military, and lighting.

State of the art lithium ion secondary batteries provide excellent charge-discharge characteristics, and thus, have also been widely adopted as power sources in portable electronic devices, such as cellular telephones and portable computers. U.S. Pat. Nos. 6,852,446, 6,306,540, 6,489,055, and “Lithium Batteries Science and Technology” edited by Gholam-Abbas Nazri and Gianfranco Pistoia, Kluer Academic Publishers, 2004, are directed to lithium and lithium ion battery systems which are hereby incorporated by reference in their entireties.

As noted above, lithium metal is extremely reactive, particularly with water and many organic solvents, and this attribute necessitates use of an intercalation host material for the negative electrode in traditional secondary lithium based electrochemical cells. Substantial research in this field has resulted in a range of useful intercalation host materials for these systems, such as LiC₆, LiₓSi, LiₓSn and Liₓ(CoSnTi). Use of an intercalation host material for the negative electrode, however, inevitably results in a cell voltage that is lower by an amount corresponding to the free energy of insertion/dissolution of lithium in the intercalation electrode. As a result, conventional state of the art dual intercalation lithium ion electrochemical cells are currently limited to providing average operating voltages less than or equal to about 4 Volts. This requirement on the composition of the negative electrode also results in substantial loss in the specific energies achievable in these systems. Further, incorporation of an intercalation host material for the negative electrode does not entirely eliminate safety risks. Charging these lithium ion battery systems, for example, must be carried out under very controlled conditions to avoid overcharging or heating that can result in decomposition of the positive electrode. Further, unwanted side reactions involving lithium ion can occur in these systems resulting in the formation of reactive metallic lithium that implicate significant safety concerns. During charging at high rates or at low temperatures, lithium deposition results in dendrides formation that may grow across the separator and cause an internal short-circuit within the cell, generating heat, pressure and possible fire from combustion of the organic electrolyte and reaction of metallic lithium with air oxygen and moisture.

Many battery technologies have been proposed for electric vehicles. The battery performance characteristics necessary for providing reasonable torque, power and range for electric vehicles are very different than those necessary for mobile electronics. The specific energy necessary to provide reasonable torque and power for an electric vehicle range of about 100 miles has been estimated to be about 100 Wh/kg. [C.-H. Dustmann, Battery Technology Handbook, Second Edition, Chapter 10, 2003.] Several battery technologies capable of providing this specific energy have been proposed for use with electric vehicles, some of which are summarized in Table 1, below. (Table reproduced from C.-H. Dustmann, Battery Technology Handbook, Second Edition, Chapter 10, 2003.) As can be seen from Table 1, the battery systems proposed for electric vehicles either do not meet the 100 Wh/kg specific energy minimum or are just above while, several of the operating temperature ranges for these battery technologies are elevated (e.g., Na/NiCl₂ and Na/S) or quite restricted (e.g., Li-polymer). Safety is also a major concern with respect to battery technology for electric vehicles and many of the candidate systems can lead to toxic gas evolution (e.g., Na/S), require significant protection of the active components (e.g., Na/NiCl₂) or have serious concerns with regard to crash safety (e.g., Li-ion). In addition, the cost of lithium has risen significantly with the adoption of Li-ion technology in the mobile handset and computing markets. Batteries based upon other technologies, therefore, are desirable for some applications, including electric vehicles which require much larger amounts of materials than mobile hand set batteries and mobile computer batteries.

TABLE 1
Proposed Electric Vehicle Battery Systems

| System | Pb/PbO | NiMH | Na/NiCl₂ | Na/S | Li-ion | Li-polymer |
|---|---|---|---|---|---|---|
| Operating | <45 | <45 | 235-350 | 285-330 | <50 | 60-80 |
| Temperature | | | | | | |
| (° C.) | | | | | | |
| Electrolyte | H₂SO₄ | KOH | β″-ceramic | β″-ceramic | LiPF₆ | Poly- |
| | | | | | | ethylene |
| | | | | | | Oxide |
| Cell OCV (V) | 2.0 | 1.2 | 2.58 | 2.1 | 4.0 | 4.0 |
| Specific | 25-35 | 40-60 | 100-120 | 110 | 80-120 | 100-120 |
| Energy | | | | | | |
| (Wh/kg) | | | | | | |
| Energy | 50-90 | 120-160 | 160-200 | 135 | 200 | 200 |
| Density | | | | | | |
| (Wh/L) | | | | | | |
| Specific | 150 | Up to | 150-180 | <75 | 500-800 | 300-400 |
| Power | | 1000 | | | | |
| (W/kg) | | | | | | |

A battery consists of a positive electrode (cathode during discharge), a negative electrode (anode during discharge) and an electrolyte. The electrolyte can contain ionic species that are the charge carriers. Electrolytes in batteries can be of several different types: (1) pure cation conductors (e.g., beta Alumina conducts with Na⁺ only); (2) pure anion conductors (e.g., high temperature ceramics conduct with O⁻ or O²⁻ anions only); and (3) mixed ionic conductors (e.g., some Alkaline batteries use a KOH aqueous solution that conducts with both OH⁻ and K⁺, whereas some lithium ion batteries use an organic solution of LiPF₆ that conducts with both Li⁺ and PF₆⁻). During charge and discharge electrodes exchange ions with electrolyte and electrons with an external circuit (a load or a charger).

There are two types of electrode reactions.

1. Cation based electrode reactions: In these reactions, the electrode captures or releases a cation Y⁺ from electrolyte and an electron from the external circuit:
Electrode+Y⁺+e⁻→Electrode(Y).
   Examples of cation based electrode reactions include: (i) carbon anode in a lithium ion battery: 6C+Li⁺+e⁻→LiC₆ (charge); (ii) lithium cobalt oxide cathode in a lithium ion battery: 2Li_{0.5}CoO₂+Li⁺+e⁻→2LiCoO₂ (discharge); (iii) Ni(OH)₂ cathode in rechargeable alkaline batteries: Ni(OH)₂→NiOOH+H⁺+e⁻ (charge); (iv) MnO₂ in saline Zn/MnO₂ primary batteries: MnO₂+H⁺+e⁻HMnO₂ (discharge).
   2. Anion based electrode reactions: In these reactions, the electrode captures or releases an anion X⁻ from electrolyte and an electron from the external circuit:
Electrode+X⁻→Electrode(X)+e⁻
   Examples of anion based electrode reactions include: (i) Cadmium anode in the Nickel-Cadmium alkaline battery: Cd(OH)₂+2e⁻→Cd+2OH⁻ (charge); and (ii) Magnesium alloy anode in the magnesium primary batteries: Mg+2OH⁻→Mg(OH)₂+2e⁻ (discharge).

Existing batteries are either of pure cation-type or mixed ion-type chemistries. Examples of pure cation-type and mixed ion-type batteries are provided below:

1. Pure cation-type of battery: Lithium ion batteries are an example of pure cation-type chemistry. The electrode half reactions and cell reactions for lithium ion batteries are:

Carbon anode:
6C+Li⁺+e⁻→LiC₆ (charge)

lithium cobalt oxide cathode:
2Li_{0.5}CoO₂+Li₊+e⁻→2LiCoO₂ (discharge)

cell reaction:
2LiCoO₂+6C→2Li_{0.5}CoO₂+LiC₆ (charge)
2Li_{0.5}CoO₂+LiC₆→2LiCoO₂+6C (discharge)
   2. Mixed ion-type of battery: A Nickel/cadmium alkaline battery is an example of a mixed ion-type of battery. The electrode half reactions and cell reactions for a Nickel/cadmium alkaline battery are provided below:

Ni(OH)₂ cathode (cation-type):
Ni(OH)₂→NiOOH+H⁺+e⁻ (charge)

Cadmium anode (anion-type):
Cd(OH)₂+2e⁻→Cd+2OH⁻ (charge)

Cell reaction:
Cd(OH)₂+2Ni(OH)₂→Cd+2NiOOH+2H₂O (charge)
   Cd+2NiOOH+2H₂O→Cd(OH)₂+2Ni(OH)₂ (discharge)
      A Zn/MnO₂ battery is an example of a mixed ion-type of battery. The electrode half reactions and cell reactions for a Zn/MnO₂ battery are provided below:

Zn anode (anion-type):
Zn+2OH⁻→ZnO+H₂O+2e⁻ (discharge)

MnO₂ cathode (cation-type)
MnO₂+H⁺+e⁻→HMnO₂ (discharge)

Cell reaction:
Zn+2MnO₂+H₂O→ZnO+2HMnO₂ (discharge)

As will be clear from the foregoing, there exists a need in the art for electrochemical cells and cell components for a range of important device applications including the rapidly increasing demand for high performance portable electronics and electric and hybrid electric vehicles.

### SUMMARY

The invention relates to soluble electrodes, including soluble anodes, for use in electrochemical systems, such as electrochemical generators including primary and secondary batteries and fuel cells. Soluble electrodes of the invention are capable of effective replenishing and/or regeneration, and thereby enable an innovative class of electrochemical systems capable of efficient recharging and/or electrochemical cycling. In addition, soluble electrodes of the invention provide electrochemical generators combining high energy density and enhanced safety with respect to conventional lithium ion battery technology. In some embodiments, for example, the invention provides a soluble electrode comprising an electron donor metal and electron acceptor provided in a solvent so as to generate a solvated electron solution capable of participating in oxidation and reduction reactions useful for the storage and generation of electrical current. Soluble negative electrodes of the present invention, for example, are highly versatile and compatible with a wide range of solid state and liquid cathode and electrolyte systems, including cathodes comprising readily available and inexpensive materials such as water and air as well as a range of solid state cathodes.

In an embodiment, the invention provides a soluble electrode for use in an electrochemical generator, the soluble electrode comprising: an electron donor comprising an electron donor metal provided in a solvent, wherein the electron donor metal is an alkali metal, an alkali earth metal, a lanthanide metal or alloy thereof; an electron acceptor provided in the solvent; wherein the electron acceptor is a polycyclic aromatic hydrocarbon or an organo radical; wherein at least a portion of the electron donor comprising an electron donor metal is dissolved in the solvent, thereby generating electron donor metal ions and solvated electrons in the solvent. In an embodiment, the soluble electrode further comprises a source of the electron donor metal, the electron acceptor or the solvent operationally connected to the electrode, such as an inlet capable of providing additional electron donor metal, electron acceptor or solvent to the electrode and/or an outlet for removing the electron donor metal, the electron acceptor or the solvent operationally connected to the electrode.

In another embodiment, the invention provides a soluble electrode for use in an electrochemical generator, the soluble electrode comprising: an electron donor comprising an electron donor metal provided in a solvent, wherein the electron donor metal is an alkali metal, an alkali earth metal, a lanthanide metal or alloy thereof; an electron acceptor provided in the solvent, wherein the electron acceptor is a polycyclic aromatic hydrocarbon or an organo radical; a supporting electrolyte comprising a metal at least partially dissolved in the solvent; wherein at least a portion of the electron donor comprising an electron donor metal is dissolved in the solvent, thereby generating electron donor metal ions and solvated electrons in the solvent. In an embodiment, the soluble electrode further comprises a source of the electron donor metal, the electron acceptor or the solvent operationally connected to the electrode, such as an inlet capable of providing additional electron donor metal, electron acceptor or solvent to the electrode and/or an outlet for removing the electron donor metal, the electron acceptor or the solvent operationally connected to the electrode.

In another embodiment, the invention provides an electrochemical generator comprising: a negative soluble electrode comprising: an electron donor comprising an electron donor metal provided in a first solvent, wherein the electron donor metal is an alkali metal, an alkali earth metal, a lanthanide metal or alloy thereof; an electron acceptor provided in the first solvent, wherein the electron acceptor is a polycyclic aromatic hydrocarbon or an organo radical; wherein at least a portion of the electron donor comprising an electron donor metal is dissolved in the first solvent, thereby generating electron donor metal ions and solvated electrons in the first solvent; a positive electrode comprising an active positive electrode material; and a separator provided between the negative soluble electrode and the positive electrode, wherein the separator is non-liquid and conducts the electron donor metal ions as a charge carrier in the electrochemical generator. In an embodiment, the electrochemical generator further comprises a source of the electron donor metal, the electron acceptor or the solvent operationally connected to the soluble negative electrode, such as an inlet capable of providing additional electron donor metal, electron acceptor or solvent to the negative electrode.

A range of electron donor metals are useful in the present invention. Metals capable of losing electrons to form strongly reductive solutions, such as alkali metals and alkali earth metals, are particularly useful in certain soluble electrodes and electrochemical generators of the invention. In some embodiments, for example, the electron donor metal of the soluble electrode and/or electrochemical generator is lithium, sodium, potassium, rubidium, magnesium, calcium, aluminum, zinc, carbon, silicon, germanium, lanthanum, europium, strontium or an alloy of these metals. In some embodiments the electron donor metal may be provided as a metal hydride, a metal aluminohydride, a metal borohydride, a metal aluminoborohydride or metal polymer. Metal hydrides are known in the art, for example in A. Hajos, “Complex Hydrides”, Elservier, Amsterdam, 1979 which is incorporated by reference herein in its entirety to the extent not inconsistent with the present description. In some embodiments, the electron donor metal of the soluble electrode and/or electrochemical generator is a metal other than lithium. Avoidance of metallic lithium is desirable in some embodiments to provide soluble electrodes and electrochemical systems providing enhanced safety upon recharging and cycling relative to conventional lithium ion systems. In addition, use of metals other than lithium can increase the ionic conductivity of the separator and increase the efficiency of the electrochemical generators of the invention. In some embodiments, the concentration of the electron donor metal ions in the solvent is greater than or equal to about 0.1 M, optionally for some applications greater than or equal to 0.2 M and optionally for some applications greater than or equal to 1 M. In some embodiments, the concentration of the electron donor metal ions in the solvent is selected over the range of 0.1 M to 10 M, optionally for some applications selected over the range of 0.2 M to 5 M and optionally for some applications selected over the range of 0.2 M to 2 M.

A range of electron acceptors are useful in the present soluble electrodes and electrochemical generators, including polycyclic aromatic hydrocarbons and organo radicals. Useful polycyclic aromatic hydrocarbons include Azulene, Naphthalene, 1-Methylnaphthalene, Acenaphthene, Acenaphthylene, Anthracene, Fluorene, Phenalene, Phenanthrene, Benzo[a]anthracene, Benzo[a]phenanthrene, Chrysene, Fluoranthene, Pyrene, Tetracene, Triphenylene Anthanthrene, Benzopyrene, Benzo[a]pyrene, Benzo[e]fluoranthene, Benzo[ghi]perylene, Benzo[j]fluoranthene, Benzo[k]fluoranthene, Corannulene, Coronene, Dicoronylene, Helicene, Heptacene, Hexacene, Ovalene, Pentacene, Picene, Perylene, Tetraphenylene, and mixtures of these. Some organo radicals of the present soluble electrodes and electrochemical generators react via a charge transfer, partial electron transfer, or full electron transfer reaction with the electron donor metal to form an organometallic reagent. Useful organo radicals include, for example, alkyl radicals (such as butyl radical or acetyl radical), allyl radicals, amino radicals, imido radicals and phosphino radicals. In some embodiments, the concentration of the electron acceptor in the solvent is greater than or equal to about 0.1 M, optionally for some applications greater than or equal to 0.2 M and optionally for some applications greater than or equal to 1 M. In some embodiments, the concentration of the electron acceptor in the solvent is selected over the range of 0.1 M to 15 M, optionally for some applications selected over the range of 0.2 M to 5 M and optionally for some applications selected over the range of 0.2 M to 2 M.

A range of solvents are useful in the present soluble electrodes and electrochemical generators. Solvents capable of dissolving significant amounts of (e.g., generating 0.1-15 M solutions of) electron donor metals and electron acceptors are preferred for some applications. In some embodiments, for example, the solvent is water, tetrahydrofuran, hexane, ethylene carbonate, propylene carbonate, benzene, carbon disulfide, carbon tetrachloride, diethyl ether, ethanol, chloroform, ether, dimethyl ether, benzene, propanol, acetic acid, alcohols, isobutylacetate, n-butyric acid, ethyl acetate, N-methylpyrrolidone, N,N-dimethyl formiate, ethylamine, isopropyl amine, hexamethylphosphotriamide, dimethyl sulfoxide, tetralkylurea, triphenylphosphine oxide or mixture thereof. In some embodiments, a mixture of solvents will be desirable such that one solvent of the mixture can solvate a electron acceptor while another solvent of the mixture can solvate a supporting electrolyte. Suitable solvents are known in the art, for example in “Lithium Ion Batteries Science and Technology”, Gholam-Abbas Nazri and Gianfranco Pistoia Eds., Springer, 2003, which is hereby incorporated by reference in its entirety.

In an aspect, for example, a supporting electrolyte comprises: MXₙ, MO_{q}, MY_{q}, or M(R)ₙ; wherein M is a metal; X is F, Cl, Br, or I; Y is S, Se, or Te; R is a group corresponding to a carboxylic group, alcohoate, alkoxide, ether oxide, acetate, formate, or carbonate; wherein n is 1, 2, or 3; and q is greater than 0.3 and less than 3.

The present soluble electrodes and electrochemical generators may further comprise a number of additional components. In an embodiment, the soluble anode further comprises a current collector provided in contact with the solvent of the positive electrode. Useful current collectors include, for example, porous carbon, a nickel metal grid, a nickel metal mesh, a nickel metal foam, a copper metal grid, a copper metal mesh, a copper metal foam, a titanium metal grid, a titanium metal mesh, a titanium metal foam, a molybdenum metal grid, a molybdenum metal mesh, and a molybdenum metal foam. Optionally, the current collector further comprises a catalyst provided to facilitate electron transport into and/or out of the current collector, such as an external catalyst layer on the outer surface of the current collector. Suitable current collectors are known in the art, for example in U.S. Pat. No. 6,214,490, which is hereby incorporated by reference in its entirety.

The separator component of the present electrochemical generators functions to conduct the electron donor metal ions between the soluble negative electrode to the positive electrode during discharge and charging of the electrochemical generator. Alternatively the separator component of the present invention is an anion conductor or a cation and anion mixed conductor. Preferably, the separator does not substantially conduct electrons between the soluble negative electrode and the positive electrode (e.g., conductivity less than or equal to 10⁻¹⁵ S cm⁻¹) and is substantially impermeable to the first solvent of the negative soluble electrode. Useful separators include ceramics, glasses, polymers, gels, and combinations of these. In an embodiment, for example, the separator comprises an electron donor metal, an organic polymer, an oxide glass, an oxynitiride glass, a sulfide glass, an oxysulfide glass, a thionitril glass, a metal halide doped glass, a crystalline ceramic electrolyte, a perovskite, a nasicon type phosphate, a lisicon type oxide, a metal halide, a metal nitride, a metal phosphide, a metal sulfide, a metal sulfate, a silicate, an aluminosilicate or a boron phosphate. The thickness of the separator can be selected so as to maximize tensile strength or to maximize ionic conductivity. In an aspect the thickness of the separator is selected over the range of 50 μm to 10 mm. For some applications the thickness is selected over the range of 50 μm to 250 μm, more preferably over the range of 100 μm to 200 μm. The electrical conductivity of the separator should be very low in order to not conduct solvated electrons between the soluble anode and the cathode. In some aspects, the electrical conductivity of the separator is less than 10⁻¹⁵ S/cm. Separators are known in the art, for example in U.S. Pat. Nos. 5,702,995, 6,030,909, 6,475,677 and 6,485,622 and in “Topics in Applied Physics, Solid Electrolytes”, S. Geller, Editor, Springler-Verlag, 1977 which are each hereby incorporated by reference in their entireties to the extent not inconsistent with the present description.

In an aspect of the invention, the active positive electrode material of the positive electrode is a fluoroorganic material, a fluoropolymer, SOCl₂, SO₂, SO₂Cl₂, M¹Xₚ, H₂O, O₂, MnO₂, CFₓ, NiOOH, Ag₂O, AgO, FeS₂, CuO, AgV₂O_{5.5}, H₂O₂, M¹M²_{y}(PO₄)_{z} or M¹M²_{y}Oₓ; wherein M¹ is the electron donor metal; M² is a transition metal or combination of transition metals; X is F, Cl, Br, I, or mixture thereof; p is greater than or equal to 3 and less than or equal to 6; y is greater than 0 and less than or equal to 2; x is greater than or equal to 1 and less than or equal to 4; and z is greater than or equal to 1 and less than or equal to 3. Suitable active positive electrode materials are known in the art, for example in U.S. Application Publication No. 2008/0280191, published Nov. 13, 2008 to Yazami et al., which is hereby incorporated by reference in its entirety.

In an embodiment, the invention provides an electrochemical generator comprising: a negative soluble electrode comprising: an electron donor comprising an electron donor metal provided in a first solvent, wherein the electron donor metal is an alkali metal, an alkali earth metal, a lanthanide metal or alloy thereof; an electron acceptor provided in the first solvent; wherein the electron acceptor is a polycyclic aromatic hydrocarbon or an organo radical; a first supporting electrolyte comprising a metal at least partially dissolved in the first solvent; wherein at least a portion of the electron donor comprising an electron donor metal is dissolved in the first solvent, thereby generating electron donor metal ions and solvated electrons in the first solvent; a positive electrode comprising: an active positive electrode material provided in contact with a second solvent; a second supporting electrolyte comprising a metal at least partially dissolved in the second solvent; and a separator provided between the negative soluble electrode and the positive electrode, wherein the separator is non-liquid and conducts the electron donor metal ions as a charge carrier in the electrochemical generator.

In an aspect of this embodiment, the supporting electrolyte comprises MXₙ, MO_{q}, MY_{q}, or M(R)ₙ; wherein M is a metal; X is —F, —Cl, —Br, or —I; Y is —S, —Se, or —Te; R is a group corresponding to a carboxylate group, alcohoate, alkoxide, ether oxide, acetate, formate, or carbonate; n is 1, 2, or 3; and q is greater than 0.3 and less than 3. In an aspect of this embodiment, the second solvent is water. In an aspect of this embodiment, the positive electrode further comprises a current collector provided in contact with the second solvent. In an aspect of this embodiment, the current collector comprises porous carbon, a nickel metal grid, a nickel metal mesh, a nickel metal foam, a copper metal grid, a copper metal mesh, a copper metal foam, a titanium metal grid, a titanium metal mesh, a titanium metal foam, a molybdenum metal grid, a molybdenum metal mesh, or a molybdenum metal foam. In an aspect of this embodiment, the soluble negative electrode further comprises a current collector provided in contact with the first solvent. In an aspect of this embodiment, the current collector comprises porous carbon, a nickel metal grid, a nickel metal mesh, a nickel metal foam, a copper metal grid, a copper metal mesh, a copper metal foam, a titanium metal grid, a titanium metal mesh, a titanium metal foam, a molybdenum metal grid, a molybdenum metal mesh, or a molybdenum metal foam. In an aspect of this embodiment, the electrochemical generator further comprises a source of the electron donor, the electron acceptor or the first solvent operationally connected to the first solvent. In an aspect of this embodiment, the electrochemical generator further comprises a source of the active positive electrode material, the second supporting electrolyte or the second solvent operationally connected to the second solvent. In an aspect of this embodiment, the electron donor metal is lithium, the electron acceptor is naphthalene, the first solvent is tetrahydrofuran, the separator is a ceramic, and the active positive electrode material of the positive electrode is O₂. In an aspect of this embodiment, the electron donor metal is lithium, the electron acceptor is biphenyl, the first solvent is tetrahydrofuran, the separator is a ceramic, and the active positive electrode material of the positive electrode is MnO₂.

The invention provides a range of electrochemical systems and generators. In an embodiment, the electrochemical generator of the invention is an electrochemical cell, such as a primary battery or a secondary battery. In an embodiment, the electrochemical generator of the invention is a fuel cell or a flow cell, optionally having a negative and/or positive electrode capable of being replenished. Flow cells and fuel cells are known in the art, for example in “Handbook of Batteries”, third edition, McGraw-Hill Professional, 2001, which is hereby incorporated by reference in its entirety to the extent not inconsistent with the present description.

In an embodiment of the invention, the invention provides a method of discharging an electrochemical generator, the method comprising: providing an electrochemical generator, the generator comprising: a negative soluble electrode comprising: an electron donor comprising an electron donor metal provided in a solvent, wherein the electron donor metal is an alkali metal, an alkali earth metal, a lanthanide metal or alloy thereof; an electron acceptor provided in the solvent; wherein the electron acceptor is a polycyclic aromatic hydrocarbon or an organo radical; wherein at least a portion of the electron donor comprising an electron donor metal is dissolved in the solvent, thereby generating electron donor metal ions and solvated electrons in the solvent; a positive electrode comprising an active positive electrode material; a separator provided between the negative soluble electrode and the positive electrode, wherein the separator is non-liquid and conducts the electron donor metal ions as a charge carrier in the electrochemical generator; and discharging the electrochemical generator.

In an embodiment of the invention, the invention provides a method of charging an electrochemical generator, the method comprising: providing an electrochemical generator, the generator comprising: a negative soluble electrode comprising: an electron donor comprising an electron donor metal provided in a solvent, wherein the electron donor metal is an alkali metal, an alkali earth metal, a lanthanide metal or alloy thereof; an electron acceptor provided in the solvent; wherein the electron acceptor is a polycyclic aromatic hydrocarbon or an organo radical; wherein at least a portion of the electron donor comprising an electron donor metal is dissolved in the solvent, thereby generating electron donor metal ions and solvated electrons in the solvent; a positive electrode comprising an active positive electrode material; a separator provided between the negative soluble electrode and the positive electrode, wherein the separator is non-liquid and conducts the electron donor metal ions as a charge carrier in the electrochemical generator; selecting a charging voltage and/or current according to a state of health of the electrochemical generator; and providing the selected voltage and/or current to the electrodes of the electrochemical generator to charge the electrochemical generator. Alternatively, the separator component of the present invention can be an anion conductor, a cation conductor, or an anion and cation mixed conductor.

In an aspect of this embodiment, the voltage and/or current provided to the electrochemical generator is preselected according to the number of charge/discharges cycles the electrochemical generator has experienced.

In an embodiment of the invention, the invention provides a method of charging an electrochemical generator, the method comprising: providing an electrochemical generator, the generator comprising: a negative soluble electrode comprising: an electron donor comprising an electron donor metal provided in a solvent, wherein the electron donor metal is an alkali metal, an alkali earth metal, a lanthanide metal or alloy thereof; an electron acceptor provided in the solvent; wherein the electron acceptor is a polycyclic aromatic hydrocarbon or an organo radical; wherein at least a portion of the electron donor comprising an electron donor metal is dissolved in the solvent, thereby generating electron donor metal ions and solvated electrons in the solvent; a positive electrode comprising an active positive electrode material; a separator provided between the negative soluble electrode and the positive electrode, wherein the separator is non-liquid and conducts the electron donor metal ions as a charge carrier in the electrochemical generator; removing substantially all of the electron donor metal, electron acceptor and first solvent from the soluble negative electrode; and providing electron donor metal, electron acceptor and first solvent to the soluble negative electrode.

Without wishing to be bound by any particular theory, there can be discussion herein of beliefs or understandings of underlying principles or mechanisms relating to the invention. It is recognized that regardless of the ultimate correctness of any explanation or hypothesis, an embodiment of the invention can nonetheless be operative and useful.

### BRIEF DESCRIPTION OF THE FIGURES

FIG. 1 provides a schematic of a cell design of an aspect of the present invention.

FIG. 2 provides a plot showing linear voltammetry (OCV→1 V, at 0.005 mV/s) for a soluble lithium liquid anode and MnO₂ cathode cell.

FIG. 3 provides a plot showing the discharge for a soluble liquid anode and MnO₂ cathode cell.

FIG. 4 provides a plot showing cyclic voltammetry (0 V [symbol] 0.645 V [symbol] 1.29 V, at 0.035 mV/s) for a lithium metal anode and soluble lithium in biphenyl electrode cell.

FIG. 5 provides a plot showing cyclic voltammetry (0 V [symbol] 0.72 V [symbol] 1.44 V, 0.035 mV/s) for a lithium metal anode and soluble lithium in naphthalene cathode cell.

FIG. 6 provides a linear voltammetry plot (OCV→4.4 V, 0.172 mV/s) showing the first voltammetric charge for a liquid lithium in biphenyl anode and LiNi_{1/3}Mn_{1/3}CO_{1/3}O₂ cathode cell.

FIG. 7 provides a plot showing cyclic voltammetry (1-4 V) for a soluble lithium in naphthalene anode and LiNi_{1/3}Mn_{1/3}CO_{1/3}O₂ cathode cell.

FIG. 8 provides a plot showing cyclic voltammetry (1-2 V) for a soluble lithium in naphthalene anode and LiNi_{1/3}Mn_{1/3}CO_{1/3}O₂ cathode cell.

FIG. 9 provides a plot showing linear voltammetry (OCV→1V, 0.005 mV/s) for a soluble lithium in biphenyl anode and MnO₂ cathode cell.

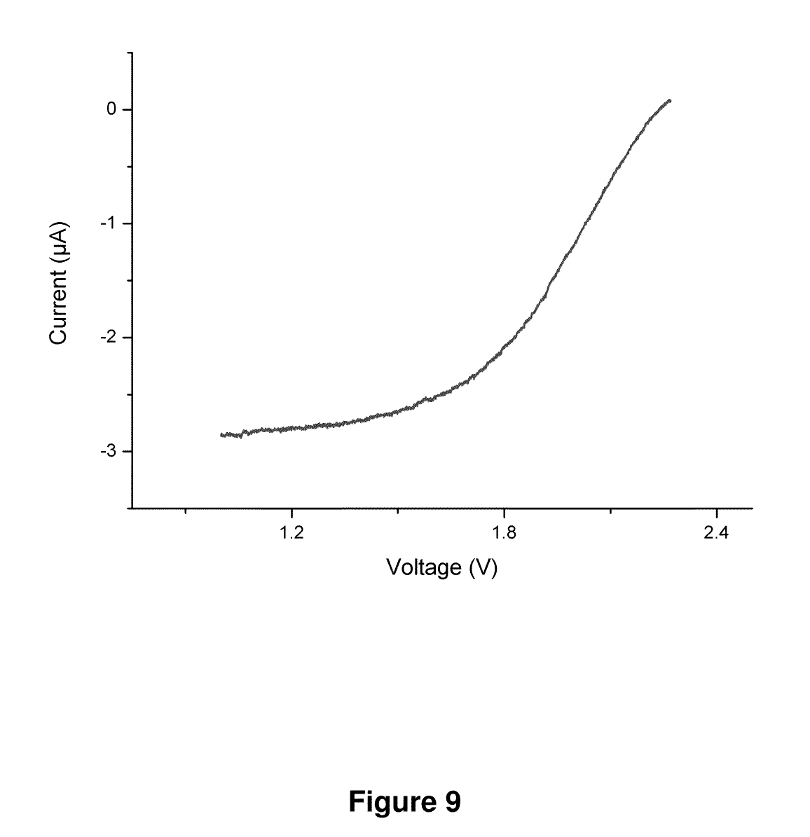

FIG. 10 provides a plot showing the discharge of a soluble lithium in biphenyl anode and MnO₂ cathode cell.

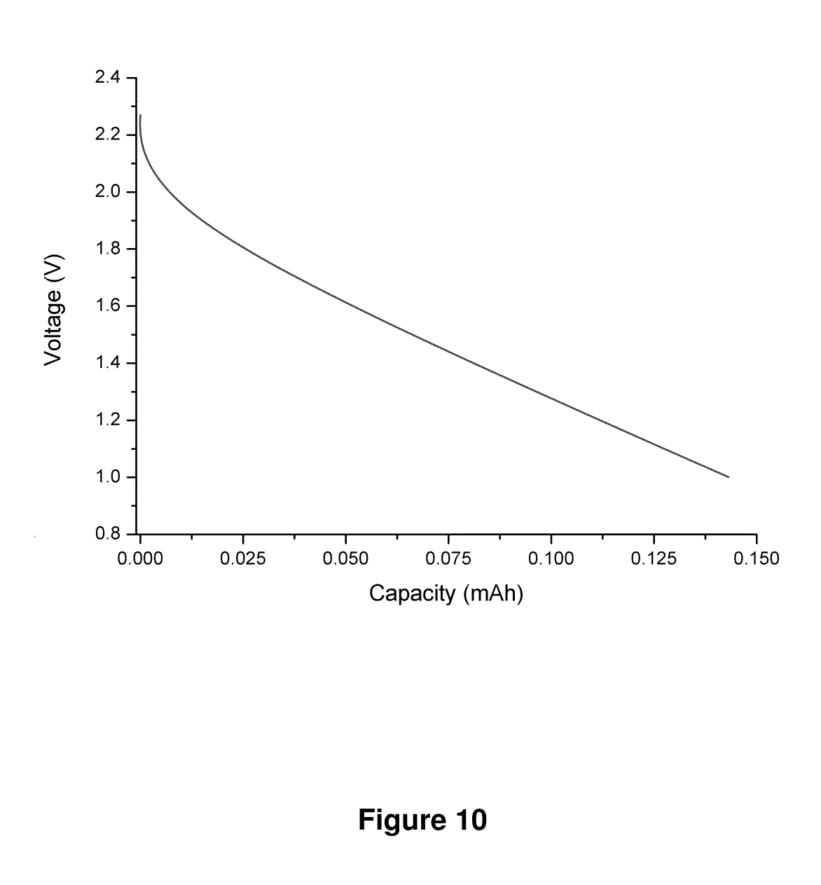

FIG. 11 provides x-ray diffractograms of MnO₂ cathodes. Trace A is an x-ray diffractogram taken after the first cell discharge of a cell employing a soluble lithium in biphenyl anode. Trace B is an x-ray diffractogram taken after discharge in a classic coin cell. Trace C is an x-ray diffractogram taken before discharge.

FIG. 12 provides a schematic of a regenerative flow cell embodiment of the invention.

### DETAILED DESCRIPTION

Referring to the drawings, like numerals indicate like elements and the same number appearing in more than one drawing refers to the same element. In general the terms and phrases used herein have their art-recognized meaning, which can be found by reference to standard texts, journal references and contexts known to those skilled in the art. The following definitions are provided to clarify their specific use in the context of the invention.

The term “electron donor metal” refers to a metal which transfers one or more electrons to another. Electron donor metals of the present invention include, but are not limited to, alkali metals, alkali earth metals, and lanthanide metals (also known as lanthanoid metals). The species to which the electron donor metal donates an electron is referred to as an “electron acceptor”. Electron donor metals and electron acceptors may combine to form solvated electron solutions and can be used to form a soluble electrode for use in an electrochemical generator.

The term “polycyclic aromatic hydrocarbon” (abbreviated “PAH”) refers to a compound which contains two or more aromatic rings. Polycyclic aromatic hydrocarbons can act as electron acceptors. Polycyclic aromatic hydrocarbons can include heterocyclic rings and heteroatom substitutions. Polycyclic aromatic hydrocarbons include, but are not limited to, Azulene, Naphthalene, 1-Methylnaphthalene, Acenaphthene, Acenaphthylene, Anthracene, Fluorene, Phenalene, Phenanthrene, Benzo[a]anthracene, Benzo[a]phenanthrene, Chrysene, Fluoranthene, Pyrene, Tetracene, Triphenylene Anthanthrene, Benzopyrene, Benzo[a]pyrene, Benzo[e]fluoranthene, Benzo[ghi]perylene, Benzo[j]fluoranthene, Benzo[k]fluoranthene, Corannulene, Coronene, Dicoronylene, Helicene, Heptacene, Hexacene, Ovalene, Pentacene, Picene, Perylene, and Tetraphenylene.

The term “organo radical” refers to an organic molecule having an unpaired electron. Organo radicals can be provided to a solution or a solvent in the form of a halide analogue of the organo radical. Organo radicals include alkyl radicals which can be provided to a solution or solvent as an alkyl halide. Organo radicals can react via a charge transfer, partial electron transfer, or full electron transfer reaction with an electron donor metal to form an organometallic reagent. Organo radicals can act as electron acceptors. The term “organometallic reagent” refers to a compound with one or more direct bonds between a carbon atom and an electron donor metal. Organo radicals include, but are not limited to, butyl and acetyl radicals.

The term “solvent” refers to a liquid, solid, or gas that dissolves a solid, liquid, or gaseous solute, resulting in a solution. Liquid solvents can dissolve electron acceptors (such as polycyclic aromatic hydrocarbons) and electron donor metals in order to facilitate the transfer of electrons from the electron donor metal to the electron acceptor. Solvents are particularly useful in soluble electrodes of the present invention for dissolving electron donor metals and electron acceptors to form electron donor metal ions and solvated electrons in the solvent.

The term “electrode” refers to an electrical conductor where ions and electrons are exchanged with electrolyte and an outer circuit. “Positive electrode” and “cathode” are used synonymously in the present description and refer to the electrode having the higher electrode potential in an electrochemical cell (i.e. higher than the negative electrode). “Negative electrode” and “anode” are used synonymously in the present description and refer to the electrode having the lower electrode potential in an electrochemical cell (i.e. lower than the positive electrode). Cathodic reduction refers to a gain of electron(s) of a chemical species, and anodic oxidation refers to the loss of electron(s) of a chemical species. Positive and negative electrodes of the present invention can be provided in a range of useful configurations and form factors as known in the art of electrochemistry and battery science, including thin electrode designs, such as thin film electrode configurations. Electrodes are manufactured as disclosed herein and as known in the art, including as disclosed in, for example, U.S. Pat. Nos. 4,052,539, 6,306,540, 6,852,446, each of which is hereby incorporated by reference in their entireties.

The term “active positive electrode material” refers to a component of a positive electrode which participates in oxidation and/or reduction of a charge carrier species during electrical charging and/or electrical discharging of an electrochemical generator.

The term “solvated electron” refers to a free electron which is solvated in a solution. Solvated electrons are not bound to a solvent or solute molecule, rather they occupy spaces between the solvent and/or solute molecules. Solutions containing a solvated electron can have a blue or green color, due to the presence of the solvated electron. Soluble electrodes comprising a solvated electron solution allow for significantly increased energy density, specific power, and specific energy when compared with state of the art commercial lithium ion based batteries.

The term “soluble electrode” refers to an electrode in which the chemical species involved in oxidation and/or reduction are provided, at least in part, in liquid form. Soluble electrodes can contain elements which do not participate in oxidation or reduction such as electrolytes, supporting electrolytes, current collectors and solvents.

The term “electrochemical generator” refers to devices which convert chemical energy into electrical energy and also includes devices which convert electrical energy into chemical energy. Electrochemical generators include, but are not limited to, electrochemical cells, primary electrochemical cells, secondary electrochemical cells, electrolysis devices, flow cells and fuel cells. The term “primary cell” refers to an electrochemical generator in which the electrochemical reaction is not reversible. The term “secondary cell” refers to an electrochemical cell in which the electrochemical reaction is reversible. The term “flow cell” refers to a system where the active electrode materials are introduced into their respective compartments from an external reservoir/container either by a continuous circulation or by an intermittent regenerative process. General electrochemical generator, cell and/or battery construction is known in the art, see e.g., U.S. Pat. Nos. 6,489,055, 4,052,539, 6,306,540, and Seel and Dahn J., Electrochem. Soc. 147(3) 892-898 (2000), each of which is hereby incorporated by reference in their entireties.

The term “electrolyte” refers to an ionic conductor which can be in the solid state, the liquid state or more rarely a gas (e.g., plasma). The term “non-liquid electrolyte” refers to an ionic conductor provided in the solid state. Non-liquid electrolytes include ionic conductors provided as a gel. The term “supporting electrolyte” refers to an electrolyte whose constituents are not electroactive during charging or discharging of the electrode or electrochemical generator which comprises the supporting electrolyte. The ionic strength of a supporting electrolyte can be much larger than the concentration of an electroactive substance in contact with the supporting electrolyte. Electrolytes can comprise a metal salt. The term “metal salt” refers to an ionic species which comprises a metal cation and one or more counter anions such that the metal salt has a net charge of zero. Metal salts can be formed by the reaction of a metal with an acid.

The terms “reducing agent” and “reduction agent” are synonymous and refer to a material which reacts with a second material and causes the second material to gain electron(s) and/or decreases the oxidation state of the second material. The terms “oxidation agent” and “oxidizing agent” are synonymous and refer to a material which reacts with a second material and causes the second material to lose electron(s) and/or increases the oxidation state of the second material. Oxidizing agents can also be electron acceptors and reducing agents can also be electron donors.

The terms “charge” and “charging” refer to the process of increasing the electrochemical potential energy of an electrochemical generator. The term “electrical charging” refers to the process of increasing the electrochemical energy in an electrochemical generator by providing electrical energy to the electrochemical generator. Charging can take place by replacing depleted active electrochemical materials of an electrochemical generator with new active compounds or by adding new active materials to the electrochemical generator.

The term “state of health” refers to the relative amount of electrochemical energy available upon discharge in an electrochemical generator when compared to a reference electrochemical generator with the same or similar components under the same or similar conditions. The first electrochemical generator can have a reduced amount of electrochemical energy available upon discharge when compared to the reference electrochemical generator due to undergoing multiple charge/discharge cycles which the reference electrochemical generator which has not undergone.

The term “separator” refers to a non-liquid material that physically separates a soluble electrode from a second electrode in an electrochemical cell. Separators can act as electrolytes and can be metal ion conductors, anion conductors or cation and anion mixed conductors. Separators can also act as electrical insulators and can have very low electrical conductivities. For example, separators can have electrical conductivities less than 10⁻¹⁵ S/cm.

### Example 1

### Liquid Alkali Metal Anode Cells

### Principle

Alkali metals (AM) and other electron donor metal ions form solvated electron (SE) solutions with a variety of molecules, including polycyclic aromatic hydrocarbons (PAHs) such as naphthalene and organo radicals such as alkyl radicals. Many polycyclic aromatic hydrocarbons are solid at room temperature and, therefore, can be provided dissolved in a suitable solvent. Solvated electron complexes can be formed by dissolving the electron donor metal in a polycyclic aromatic hydrocarbon solution such as naphthalene in tetrahydrofuran. The solution takes a green-blue color characteristic of solvated electron complexes.

We used AM-PAH based solvated electron solutions as a working liquid anode for battery applications. The active cathode material in these systems can be as simple as air, water, MnO₂ or more complex, such as LiMn_{1/3}Ni_{1/3}CO_{1/3}O₂ (LMNCO). The electrochemistry for cells having a soluble alkali metal in polycyclic aromatic hydrocarbon anode is provided below:

Alkali metal dissolution:

AM+nPAH→AM⁺+(e⁻,nPAH)⁻ (1)

Anode reaction (discharge):

(e⁻,nPAH)⁻→nPAH+e⁻ (2)

Cathode reaction (in case of air):

O₂+2AM⁺+2e⁻→(AM)₂O₂ (3)

Total discharge reaction for an alkali metal solvated electron anode and air cathode battery:

2AM⁺+2(e⁻,nPAH)⁻+O₂→(AM)₂O₂+2nPAH (4)

### Experimental and Results

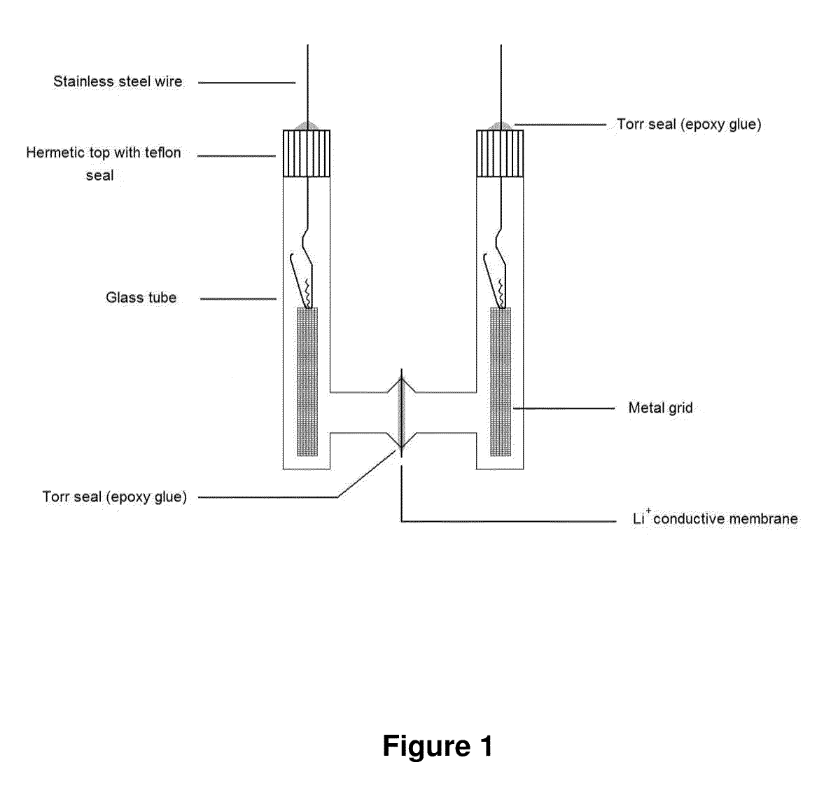

The experimental cell used to conduct experiments is shown in FIG. 1. The experimental cell includes two glass tubes separated by a Li⁺ conductive membrane held together with epoxy glue (Torr seal). The glass tubes are sealed at the top by hermetic Teflon seals. A metal grid is provided as a current collector to each tube. Stainless steel wires are connected to the current collectors and pass through the hermetic Teflon seal at the tops of the glass tubes and held in place by an epoxy glue (Torr seal).

The open circuit voltages of two cells were measured using a multimeter. The first cell was a lithium metal and naphthalene liquid anode with an air in water cathode. The open circuit voltage of this cell was measured as 2.463 V. The second cell was a lithium metal and naphthalene liquid anode with a MnO₂ in propylene carbonate cathode. The open circuit voltage of this cell was measured as 2.312 V.

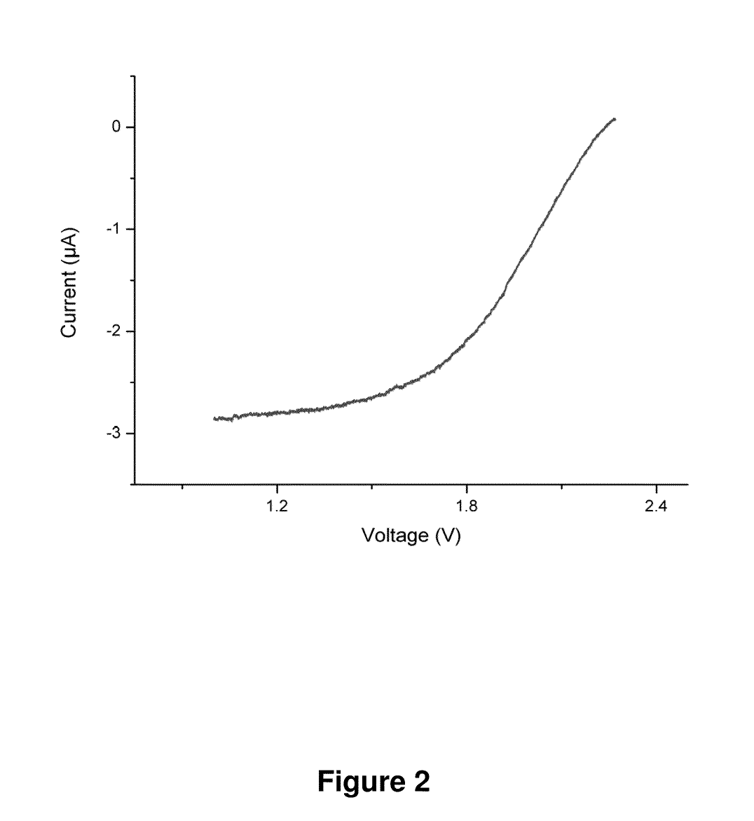

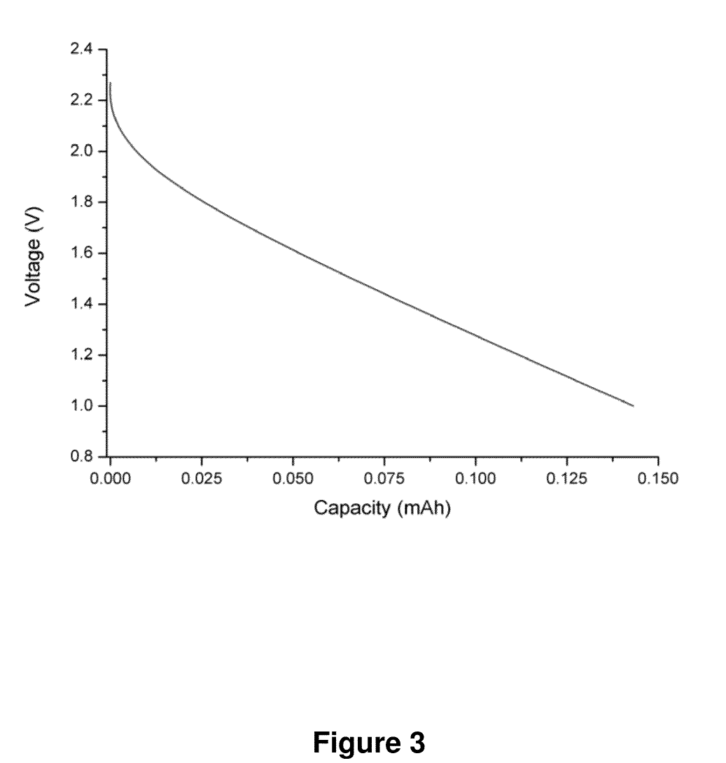

The linear voltammetry of the lithium metal in naphthalene liquid anode and MnO₂ in propylene carbonate cathode cell was measured from the open current voltage to one volt above the open circuit voltage at 0.005 mV/s. The results are shown in FIG. 2. The discharge of the same cell was measured and is shown in FIG. 3. These results show that a cell with an alkali metal and polycyclic aromatic hydrocarbon soluble anode produces enough free electrons and lithium metal ions in the anode such that significant charging and discharging of the cell is achieved.

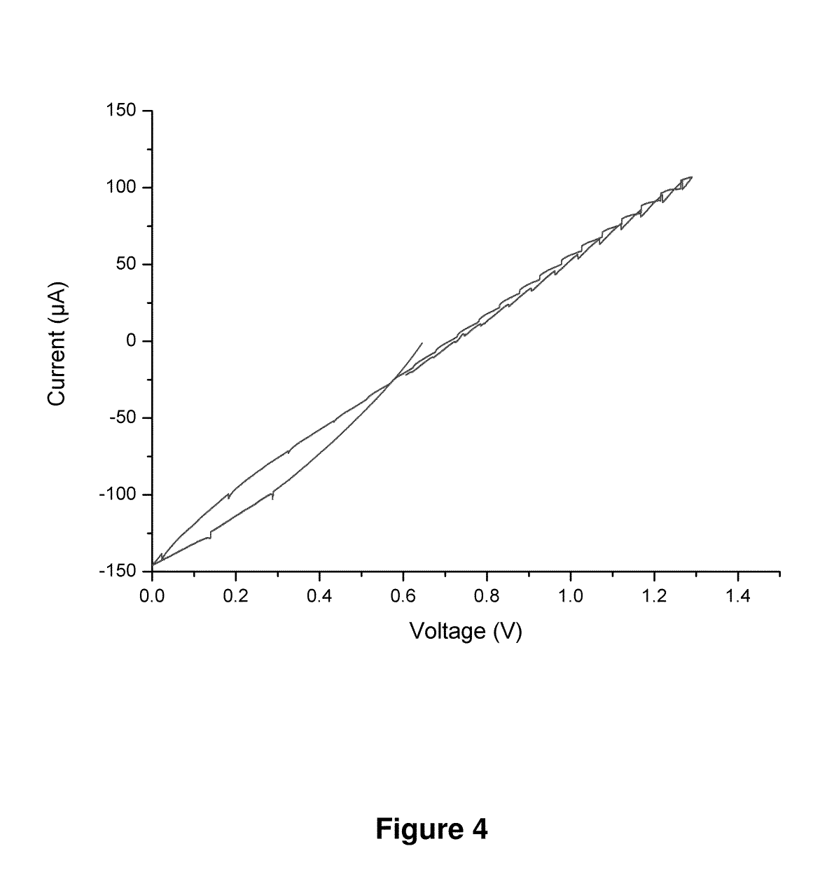

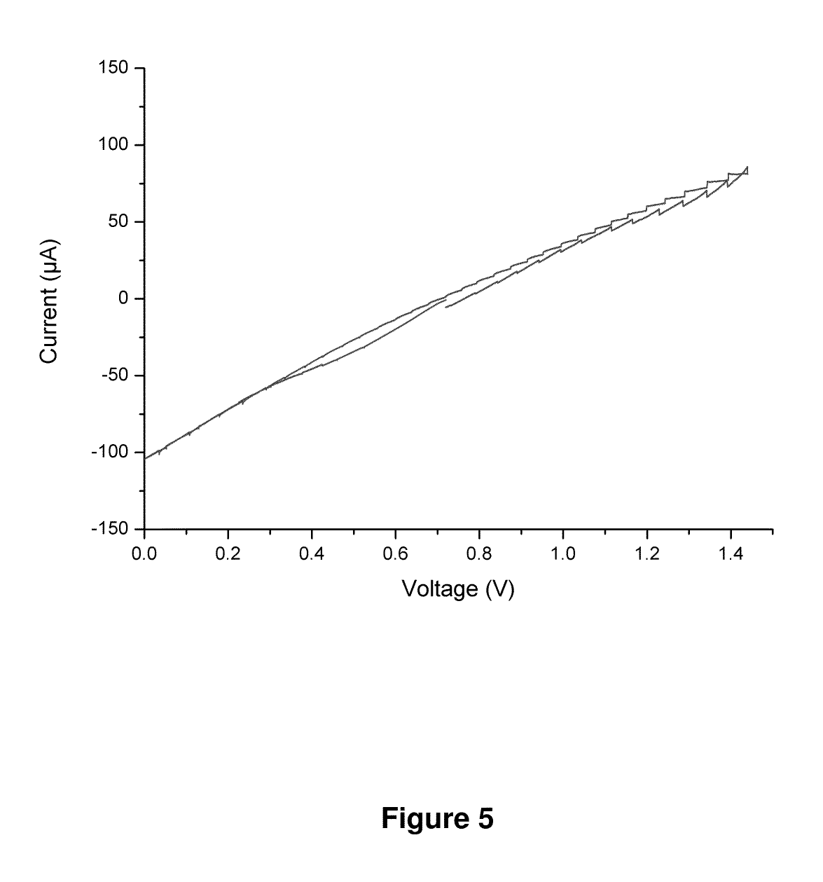

A lithium metal reference electrode and lithium in biphenyl soluble electrode of the half cell was constructed and cyclic voltammetry from the open circuit voltage through 0.645 V to 1.29 V was measured at 0.035 mV/s. The results are shown in FIG. 4. A lithium metal reference electrode and lithium in naphthalene soluble electrode half cell was constructed and the cyclic voltammetry from the open circuit voltage through 0.72 V to 1.44 V was measured at 0.035 mV/s. The results are shown in FIG. 5. These cyclic voltammetry experiments show that the alkali metal and polycyclic aromatic hydrocarbon can act as a soluble electrode in a rechargeable battery system.

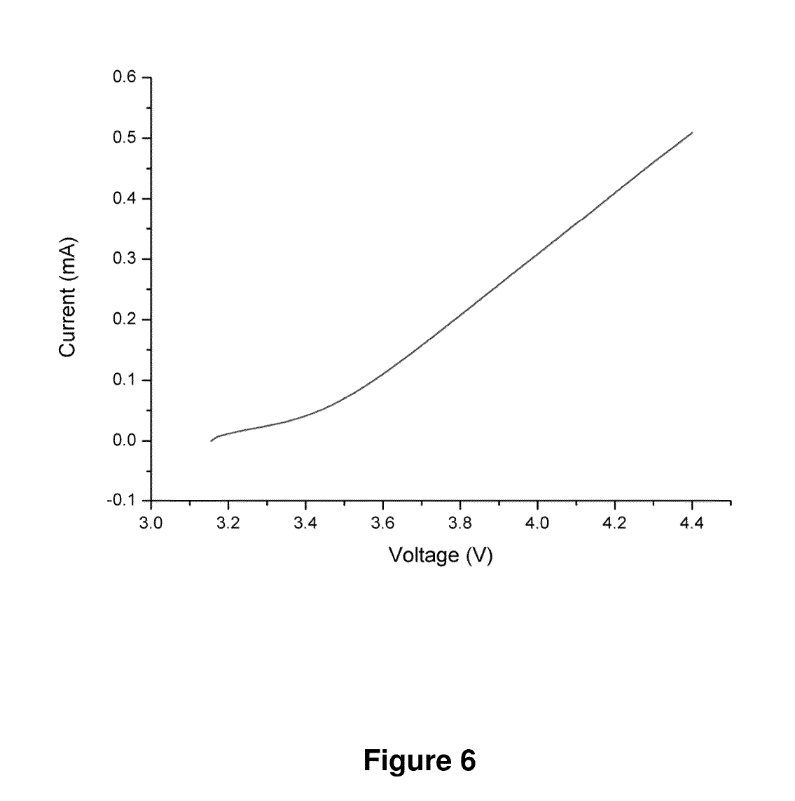

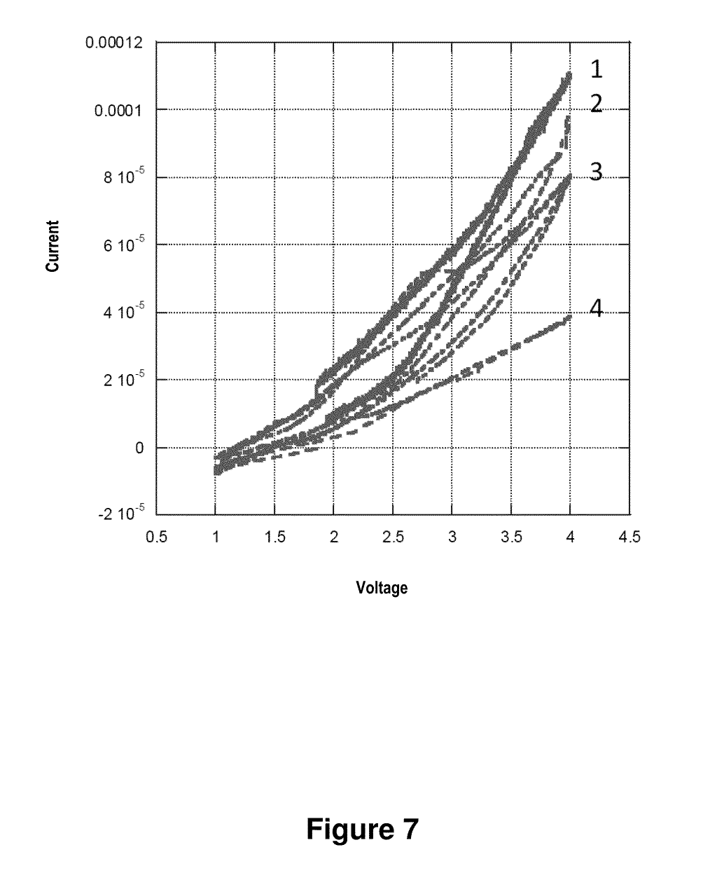

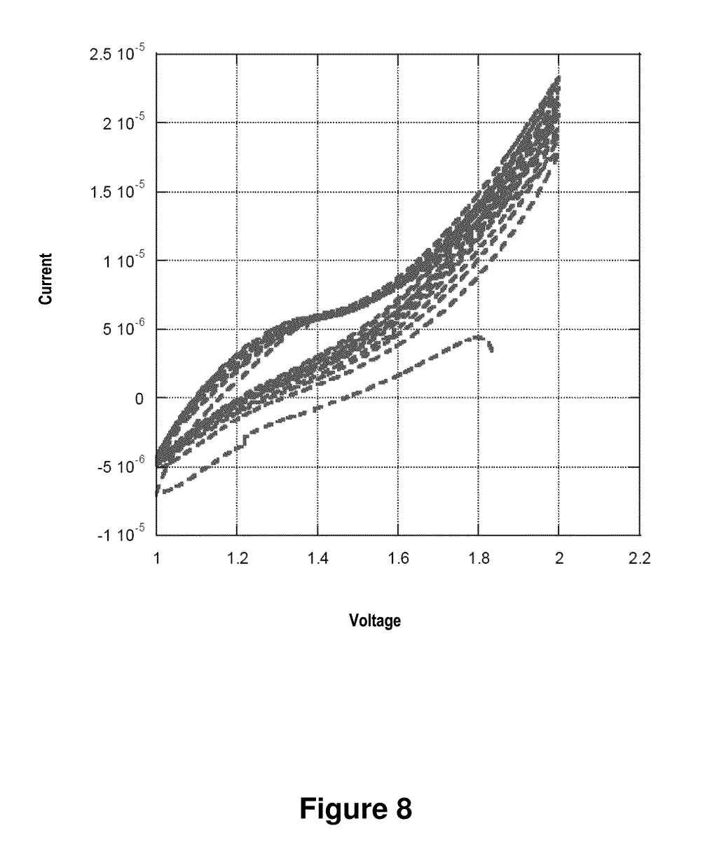

A lithium in naphthalene soluble anode and LiNi_{1/3}Mn_{1/3}CO_{1/3}O₂ cathode cell was constructed. The linear voltammetry of this cell was measured from the open circuit voltage to 4.4 V at 0.172 mV/s. The results are shown in FIG. 6. Note that this charging curve is nearly linear from between about 3.2 V to about 4.4 V. The cyclic voltammetry from 1 to 4 volts for the same cell was measured and the results are shown in FIG. 7. The cyclic voltammetry for this cell was also measured between 1 and 2 volts and is shown in FIG. 8.

### Example 2

### Realization of a Liquid Lithium Anode Cell

### Principle

It is known that lithium can be dissolved in solutions containing polycyclic aromatic hydrocarbons such as naphthalene or biphenyl due to the high electron affinity of the polycyclic aromatic hydrocarbons. The reaction forming solvated electrons for both biphenyl and naphthalene are shown in eq. 12 and 13, below. Such lithium solutions, however, are not used in commercial electrochemistry applications because of their extreme reactive character and also the lack of useful resistant membranes which both separate the solvated electron solution from the cathode while at the same time allowing transfer of metal ions between the solvated electron solution and the cathode in a separate compartment.

2Li₍ₘₑₜₐₗ₎+biphenyl→[2Li⁺,(2e⁻,biphenyl)] (eq. 12)

2Li₍ₘₑₜₐₗ₎+naphthalene→[2Li⁺,(2e⁻,naphthalene)] (eq. 13)

Ohara Corporation has recently developed, and we have obtained, a new Lithium-Ion Conducting Glass-Ceramic (LIC-GC) membrane. This separator possesses one of the highest Li-ion conductivity values for a solid electrolyte (on the order of 1×10⁻⁴ S·cm⁻¹ at 25° C.), outstanding chemical resistance properties and excellent physical and mechanical properties with a 150 μm thickness. These attributes make the membrane extremely useful in an electrochemical generator as a separator and electrolyte. After some tests, we confirmed that the membrane is liquid lithium solution resistant. Indeed, we used it to build a very innovative battery with a liquid lithium anode.

### Experimental

A cell was designed to run experiments to prove that liquid lithium solutions can be successfully employed as a soluble anode in an electrochemical generator. The cell is composed of two glass compartments separated by the Li⁺ conductive membrane (FIG. 1). Two similar models of this cell were made.

Four types of liquid lithium solutions were used as the soluble anode for these investigations (all molar in each constituent): THF/Biphenyl/Lil/Li₍ₛ₎, THF/Naphthalene/Lil/Li₍ₛ₎, THF/Biphenyl/LiCl/Li₍ₛ₎, and THF/Naphthalene/LiCl/Li₍ₛ₎. In these solutions, the polycyclic aromatic hydrocarbon (naphthalene or biphenyl) is dissolved in tetrahydrofuran (THF). Lithium metal is added to this solution and the lithium donates an electron to the solution, thus forming lithium ions and solvated electrons in the solution. The LiCl and Lil salts are added to the solution as an electrolyte to increase the conductivity of the solution.

20 ml of each solution were prepared under argon in a glove box. Lil and LiCl were added as a source of Lit Note that Li₍ₛ₎ is totally soluble in both naphthalene and biphenyl solutions because one mole of each compound can dissolve two moles per liter of Li₍ₛ₎. Also, note that LiCl is not soluble up to 1M in THF. All solutions have a dark blue color due to the presence of solvated electrons.

After we made sure that liquid lithium solutions did not react with the membrane, Torr seal or metal grid, four kinds of tests were carried out:

First test: To prove that the principle works experimentally, a cell was constructed of a liquid lithium in biphenyl anode solution and a MnO₂ cathode recovered from a classic Li/MnO₂ coin cell. The cell reaction is shown in eq. 14.

[Li⁺,(e⁻,biphenyl)]+MnO₂→LiMnO₂+biphenyl (eq. 14)

Reverse test: To verify that Li ion can circulate from the anode to the cathode and from the cathode to the anode, batteries composed of a metal lithium anode and a liquid lithium cathode were made (see eq. 15).

(biphenyl or naphthalene)+Li₍ₘₑₜₐₗ₎ [symbol] [Li⁺,(e⁻,biphenyl or naphthalene)] (eq. 15)

Color test: To confirm that Li ion can totally be transferred between the anode and cathode, cells made up of a liquid lithium anode and only THF/LiX/naphthalene or biphenyl (X=I or Cl) as cathode (see eq. 16).

[Li⁺,(e⁻,biphenyl or naphthalene)]+(biphenyl or naphthalene)_{cathode side}→(biphenyl or naphthalene)_{anode side}+[Li⁺,(e⁻,biphenyl or naphthalene)] (eq. 16)

Water test: To prove that this kind of battery can work with a cathode as simple as water, cells made up of a liquid lithium anode and a salt water cathode were prepared (see eq. 17).

[Li⁺,(e⁻,biphenyl or naphthalene)]+H₂O→1/2H₂+LiOH (eq. 17)

For each kind of test, several cells have been tested and improved by modifying some parameters or using different liquid lithium solutions as a comparison. Features of all these cells are detailed in Table 2, below.

TABLE 2
Experimental Cell Components, Experiments, and Open Current
Voltages (OCV)

| | | Metal | | Metal | | |
|---|---|---|---|---|---|---|
| | | grid | | grid | Cell | |
| Name of | | (Anode | | (Cathode | OCV | Electrochemical |
| the cell | Anode | side) | Cathode | side) | (V) | experiments |
| First test | 1M THF/biphenyl/ | Al | MnO2 in 1M | Al | 2.281 | Linear voltammetry |
| | LiI/Li | | LiClO₄/PC | | | |
| Reverse | Metal Lithium in 1M | Al | 1M THF/biphenyl/ | Al | 0.700 | Cyclic voltammetry |
| tests | LiClO₄/PC | | LiI/Li | | | |
| | Metal Lithium in 1M | — | 1M THF/biphenyl/ | Al | 0.766 | Cyclic voltammetry |
| | LiBF₄/PC/DME | | LiI/Li | | | |
| | Metal Lithium in 1M | — | 1M THF/biphenyl/ | Cu foam | 0.645 | Cyclic voltammetry |
| | LiBF₄/PC/DME | | LiI/Li | | | |
| | Metal Lithium in 1M | — | 1M THF/ | Cu foam | 0.720 | Cyclic voltammetry |
| | LiBF₄/PC/DME | | naphthalene/LiI/Li | | | |
| Color | 1M THF/ | Cu | 1M THF/ | Cu foam | 1.200 | Linear voltammetry |
| tests | naphthalene/LiI/Li | foam | naphthalene/LiI | | | and then constant |
| | | | | | | voltage (−1.158 V) |
| | | | | | | during 3 days |
| | 1M THF/ | Cu | 1M THF/ | Cu foam | 1.103 | Constant current (−3.51 mA) |
| | naphthalene/LiI/Li | foam | naphthalene/LiCl | | | during |
| | | | | | | 24 h |
| | 1M THF/ | Cu | 1M THF/ | Cu foam | 2.177 | Constant current (−3.51 mA) |
| | naphthalene/LiCl/ | foam | naphthalene/LiCl | | | during |
| | Li | | | | | 24 h |
| | 1M THF/biphenyl/ | Cu | 1M THF/biphenyl/ | Cu foam | 1.760 | Constant current (−0.977 mA) |
| | LiCl/Li | foam | LiCl | | | during |
| | | | | | | 96 h |
| Water | 1M THF/ | Cu | 1M H₂O/LiCl | Ni | 2.6 | Linear voltammetry + |
| tests | naphthalene/LiI/Li | foam | | | | HCl addition |
| | | | | | | (cathode side) at |
| | | | | | | the end to increase |
| | | | | | | OCV (2.19→2.62 V) |
| | 1M THF/ | Cu | 1M H₂O/LiCl | Cu foam | 2.32 | Linear voltammetry |
| | naphthalene/LiCl/ | foam | | | | |
| | Li | | | | | |
| | 1M THF/biphenyl/ | Cu | 1M H₂O/LiCl | Ni | 2.613 | Linear voltammetry |
| | LiCl/Li | foam | | | | |

Before being tested, each cell was carefully washed with acetone and dried in an oven at 100° C. The metal grid current collectors were also washed and dried in this manner. Cells were then filled in a glove box under argon atmosphere and removed to first record their open circuit voltage (OCV) and then to run electrochemical experiments. Electrochemical experiments carried out included linear and cyclic voltammetry (current recording versus applied potential gradient) to study discharge or investigate rechargeable capabilities of the cells. Voltammetry measurements were recorded on a voltalab PGZ 301 system. After several measurements, each cell was recycled by burning the Torr seal glue to remove the electrolyte membrane separator and separate both parts of the cell. Finally, a new cell was built with a new separator and use for further tests.

X-ray diffraction (XRD) analyses was also carried out on MnO₂ cathode samples before and after discharge (by linear voltammetry) of the first cell and compared to a MnO₂ cathode sample recovered after discharge of a classic coin cell with a Li metal anode and the MnO₂ cathode. XRD measurements were carried out on a Philips X′Pert Pro at 45 kV and 40 mA.

### Results—First Test

The current vs. voltage data obtained by linear voltammetry (FIG. 2) has been converted into a classic voltage vs. capacity discharge curve (FIG. 3). Capacity is calculated from the current vs. time curve by the following equation 18:

Q=∫_{t=Q}^{t}I(t)dt eq. 18

The linear voltammetry curve shows that a low discharge current passes through the cell when the applied potential was decreased, also current seems to reached a limit around −3 μA. The fact that we obtained such a low current can be explained by the very low voltage scan speed and also by the low membrane surface area (approximately 1 cm²). Indeed, a relatively low capacity is reached at the end of the voltammetry (around 0.143 mAh), as can be seen in FIG. 3. Moreover, the amount of Li⁺ which passes through the membrane to insert in MnO₂ can be calculated from the capacity value by the following equation 19:

$${n}_{Li} = \frac{0.143 \times 3.6}{96500} = 5.33 \times {10}^{- 6} mol \qquad eq . 19$$

To confirm that Li ion was effectively passed through the membrane to insert in MnO₂ structure to give LiMnO₂, we have carried out some XRD analyses of MnO₂ cathode before and after the discharge.

MnO₂-type which is used as a cathode in Li/MnO₂ primary batteries is γ-MnO₂. The γ-MnO₂ structure exhibits both Rutile with (1×1) channels and Ramsdelite with (2×1) channel domains. The (2×1) channels can accommodate Li⁺ ions far more readily than the (1×1) channels. At the end of a cell discharge, the hexagonal-close-packed oxygen lattice is substantially distorted by lithium insertion and ideally resembles an α-MnOOH-type structure (groutite). But in a fully lithiated γ-MnO₂ product it is unlikely that the hexagonally-close-packed oxygen array will remain stable due to electrostatic interactions between Li⁺ and the Jahn-Teller (d⁴) Mn³⁺ ions in face-shared octahedral configuration. It is therefore probable that the structure will be modified away from an ideal α-MnOOH-type structure to accommodate these interactions.

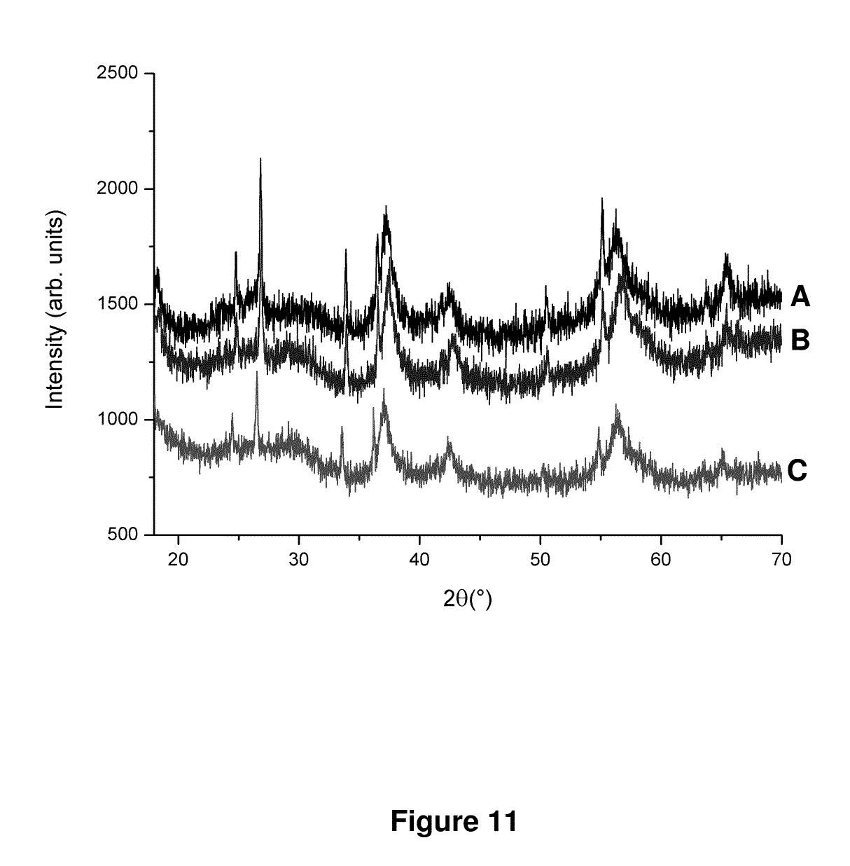

X-ray diffractograms of MnO₂ cathodes after both first cell and classic coin cell discharge are similar to the MnO₂ cathode XRD before discharge (FIG. 11). Indeed, they have certainly the same crystalline structure but nevertheless, both of the MnO₂ after discharge diffractograms traces are more similar than the one before discharge. Those results are consistent with the fact that only a small quantity of Li ion passed through the membrane to insert in the MnO₂ cathode which are indeed not at all fully lithiated at the end of the linear voltammetry.

### Results—Reverse Tests

Two cyclic voltammetry measurements, one with lithium naphthalide (naphthalene) solution (FIG. 5) and one with solution of lithium biphenyl (FIG. 4), have been carried out.

The first observation is that the OCV (open current voltage) of the cell made up with biphenyl is lower than the OCV of the cell made up with naphthalene. Indeed, reductive potential of the solution of lithium biphenyl is closer, to the one of metal lithium, than the one of lithium naphthalide. This is contrary to the fact that the biphenyl electron affinity is higher (0.705) than the naphthalene one (0.618) based on mₘ₊₁. The term mₘ₊₁ is the Hückel value of the coefficient of the molecular orbital resonance integral in the expression for the energy of the lowest unoccupied orbital of the arene. [Taken from A. Streitwieser, jun., “Molecular Orbital Theory for organic Chemists”, Wiley, New York, 1961, p178.]

Aspects of both cyclic voltammetry curves show that both oxidation and reduction processes of the two electrodes is reversible, with only a small amount of hysteresis observed. An interesting jagged shape of the curve is obtained during both charge and discharge between the OCV and twice the OCV.

If we compare the two cyclic voltammetry curves, we can see that the only difference is that a higher current is reached when the solution of lithium biphenyl is used.

### Results—Water Test

For this test, cathode side compartment containing a solution of 1M H₂O/LiCl remained open because of the hydrogen gas formation during cell discharge. Good results haven't been obtained probably due to liquid lithium solution quality once again. Actually, after every experiment, the dark blue color of liquid lithium solutions changed to a milky one, that's mean Li was oxidized. First we thought that was a cell leak problem but after some tests it was actually a glove box problem because color of solutions started to change inside the latter. After those finding, the glove box was regenerated but we hadn't enough time and material (membranes) to run other test like this one.

Nevertheless, interesting results that we can find out of those experiments is that a relatively high OCV is available with these Li_{(liq)}/H₂O cells (around 2.6 V). Moreover, addition of HCl to water at the end of the discharge of those cells contributes to enhance the OCV (2.19→2.62 V) by increasing the H⁺ concentration.

### Results—Last Test

Several tests were performed after the regeneration of the glove box using a new liquid lithium solution (biphenyl) and a special cathode provide to us by ENAX, Co., Japan. The compound formula that composed this cathode is LiNi^{II}_{1/3}Co^{III}_{1/3}M^{IV}_{1/3}O₂. The cathode is made of an aluminum foil enrobed by this compound. Features of this material allow making a rechargeable battery between 3.2 and 4.5 V (vs. Li metal). First result has shown an OCV of 3.16 V, very close to the one expected vs. Li metal. This means Li metal and liquid lithium solution potentials are closer than we have previously found. This is can be due to the higher quality of the liquid lithium solution prepared after the glove box regeneration. A linear voltammetry was carried out on this cell to charge it (FIG. 6). Results show that higher currents are available (around 500 μA) that had never been reached before. Finally, these last tests give the proof that liquid lithium solutions used for the previous tests were certainly a little bit oxidized and better results will surely be obtained for future experiments.

### Example 3

### A Hybrid Electrochemical Generator with a Soluble Anode

Since their commercialization in the early 1990s lithium ion batteries (LIBs) have become the dominant electrical power source in most portable electronics such as cellular phones and laptop computers and are tested in automobile applications such as in hybrid cars, plug-in hybrids and electrical vehicles. The obvious advantage of lithium ion batteries compared to other battery chemistries is a high energy density of over 200 Wh/kg more than twice that of alkaline batteries and five times that of lead acid batteries [1]. Theoretical (maximum) energy density of current LIBs is in the order of 450 Wh/kg. On the other hand, primary (non rechargeable) lithium batteries using polycarbon monofluoride as the cathode material (Li/CFx) have demonstrated up to 650 Wh/kg. Therefore a compromise in energy density has been set vs. rechargeability. Here we introduce a new chemistry that allows for rechargeability and high energy density. The chemistry is based on the soluble anode where the battery is no more recharged electrically but by feeding the anode and the already existing cathode with active materials like in fuel cells. The anode here is in the liquid state (solution), whereas all known commercial batteries use solid state anodes.

In an electrochemical power source the active materials involved in the anode, the cathode and the electrolyte composition can be found in the three states of matter; solid, liquid and gas. Current lithium batteries use a solid state cathode (positive pole) based on metal oxides or phosphates, a solid state anode (negative pole) based on metallic lithium (in primary cells) and lithiated carbon (in rechargeable cells) and a liquid state organic electrolyte. Both lithium and lithiated carbon anodes provide a high energy and a high power density. However, combining a solid state anode and an organic liquid electrolyte has been identified as the cause of the battery thermal runaway, which raises serious safety issues, especially in large size systems such as those considered for hybrid and electric cars application. Moreover, only electrical recharge is applicable to lithium ion batteries, which requires long times and limits the energy density to about 200 Wh/kg. The advantage of fuel cells vs. batteries resides in the fact that they can be fed with active materials from an external tank, which extends the loaded energy and reduces the “recharge” time. Polymer electrolyte membrane (PEM) fuel cells use gaseous hydrogen and methanol as the active anode materials and oxygen as the active cathode. The electrolyte is a solid state membrane. To operate PEMs requires expensive catalysts to be used on the carbon supported anode and cathode materials, yet the achieved power density is not high enough for transportation applications.

The table below (Table 3) summarizes the physical state of active electrode materials in some of the battery and fuel cells systems and introduces the new soluble anode technology.

TABLE 3
Physical State of Active Electrode Materials for Classic Batteries and
Fuel Cells and for the Soluble Anode Technology

| | | | | | Electrolyte/ | |
|---|---|---|---|---|---|---|
| Electrochemical | Anode | | Cathode | | Separator | |
| System | Material | State | Material | State | Material | State |

Present Technologies

| | | | | | | |
|---|---|---|---|---|---|---|
| Lithium Ion | Caron | Solid | Metal Oxide | Solid | Organic | Liquid |
| Lithium-air | Lithium | Solid | Air | Gas | Ceramic | Solid |
| Lithium | | | | | | |
| Primary | | | | | | |
| Li/MnO₂ | Lithium | Solid | MnO₂ | Solid | Organic | Liquid |
| Li/SOCl₂ | Lithium | Solid | SOCl₂ | Liquid | Organic | Liquid |
| Fuel Cell | | | | | | |
| PEMFC | O₂ (air) | Gas | H₂ | Gas | Membrane | Solid |
| DMFC | O₂ (air) | Gas | Methanol | Liq./Gas | Membrane | Solid |

Soluble Anode Technology

| | | | | | | |
|---|---|---|---|---|---|---|
| Li-organic | Li-organic | Liquid | SOCl₂/SO₂ | Liquid | Ceramic/ | Solid |
| | | | | | Polymer | |
| Li- | Li-organic | Liquid | H₂O | Liquid | Ceramic/ | Solid |
| organic/water | | | | | Polymer | |

The requirements for an anode material for battery application are:
Low operating voltage V⁻, this allows the full cell voltage V to be as high as possible (V=V⁺−V⁻, V⁺=the cathode operating voltage);
Low equivalent weight and volume, this relates to the energy density of the full in Wh/kg and Wh/l;
Fast kinetics, this relates to the power density (W/kg and W/l) in a large range of operating temperatures;
Chemical stability with electrolyte, this relates to the battery self-discharge rate;
Thermal stability, this relates to safety;
Environmentally benign and recyclability; and
Low cost (for $/Wh and $/W of the cell).

The lithiated carbon anode fulfills all these requirements except the high energy density as compared to metallic lithium and to some extent the safety one. The typical recharge time is in the order of one to five hours, which may not be practical in electric automobile applications. Lithium is known to form strongly reductive solutions such as butyl-lithium in hexane, lithium diphenylide and lithium naphthalenide in tetrahydrofuran (THF). For the later the dissolution reaction can be schematized as (reactants and products in THF):

Liₘₑₜₐₗ+C₈H₁₀ [symbol] Li(C₈H₁₀)ₛₒₗᵤₜᵢₒₙ (20)

In contact with an electrode, such as a porous carbon electrode, Li(C₈H₁₀) can act as an anode material to release the lithium cation (reactants and products in THF):

Li(C₈H₁₀) [symbol] Li⁺(solution)+e−(carbon)+C₈H₁₀(solution) (21)

Adding metallic lithium will restore the active Li(C₈H₁₀) material in the solution according to Eq. 20, therefore acting as a “chemical” recharge of the anode. The so formed Li⁺ cation will migrate through the solid state electrolyte to the cathode side of the cell where a reduction takes place. Should water or oxygen be used as the cathode active material, the respective reactions are:

Li⁺+e⁻+H₂O [symbol] LiOH+1/2H₂ (22)

Li⁺+e⁻⁺1/2O₂ [symbol] 1/2Li₂O (23)

Accordingly, the full cell reactions are:

Li(metal)+H₂O [symbol] LiOH+1/2H₂ (24), and

2Li(metal)+1/2O₂ [symbol] Li₂O (25).

The corresponding cell's open circuit voltages are e₅=2.59V and e₆=3.29V and theoretical energy density is 2.78 kWh/kg and 5.88 kWh/kg, respectively. In a practical battery the weight of other cell's components such as C₁₀H₈, THF, water, solid electrolyte and hardware are added, which can reduce the energy density by a factor of 2 to 4, depending on cell engineering. In a conservative assumption (reduction factor of 4) the two battery systems can still yield 695 Wh/kg and 1470 Wh/kg practical energy density, respectively.

Since dissolution of metallic lithium according to Eq. 20 is well documented, there are two major issues to be addressed for a soluble lithium anode based battery to operate:

### I. Set Up a 2- and 3-Electrode Half Cells

Two- or three-electrode half cells can be designed to measure the open circuit voltage and the electrode kinetics. The corresponding electrochemical chain is:

(+)Carbon/Li(C₈H₁₀) in THF//ceramic separator//LiX in organic solvent/Li(−)

In the 3-electrode design an additional lithium reference electrode can be used in the right compartment of the cell. LiX is a soluble lithium salt such as LiPF₆ or LiBF₄ and organic solvent can be chosen among those used in lithium primary and rechargeable batteries such as propylene carbonate and ethylene carbonate. The main difficulty here is to insure the ceramic electrolyte makes a physical separation between the two liquid phase systems in the carbon anode compartment and the metallic lithium compartment. Solid state electrolytes such as those commercially available and highly stable lithium metal phosphates glasses and ceramics can fulfill such a task.

### II. Set Up a Full Cell

The full cell can be schematized as:

(−)Carbon/Li(C₈H₁₀) in THF//ceramic-separator//water/Carbon(+)

The full cell requires metallic lithium feed system on the anode side and a water (or air) feed system on the cathode side. Solutions can be found to match the reactive feeding rate with the discharge rate. For low and high temperature operations, other liquid cathode materials can be used, such as commercial SOCl₂ and SO₂ solutions in organic solvents.

Alternatively LiOH and Li₂O products can be recycled to produce metallic lithium by electrolysis, for example. Also the hydrogen produced in reaction (3) can be used as the fuel in a PEM fuel cell adding more power to the system.

### REFERENCES

1. Handbook of Batteries, Third Edition, David Linden and Thomas B. Reddy, Eds., McGraw-Hill handbooks, 2002.

### Example 4

### Liquid Anode Based Battery with Anode and Cathode Regeneration Systems

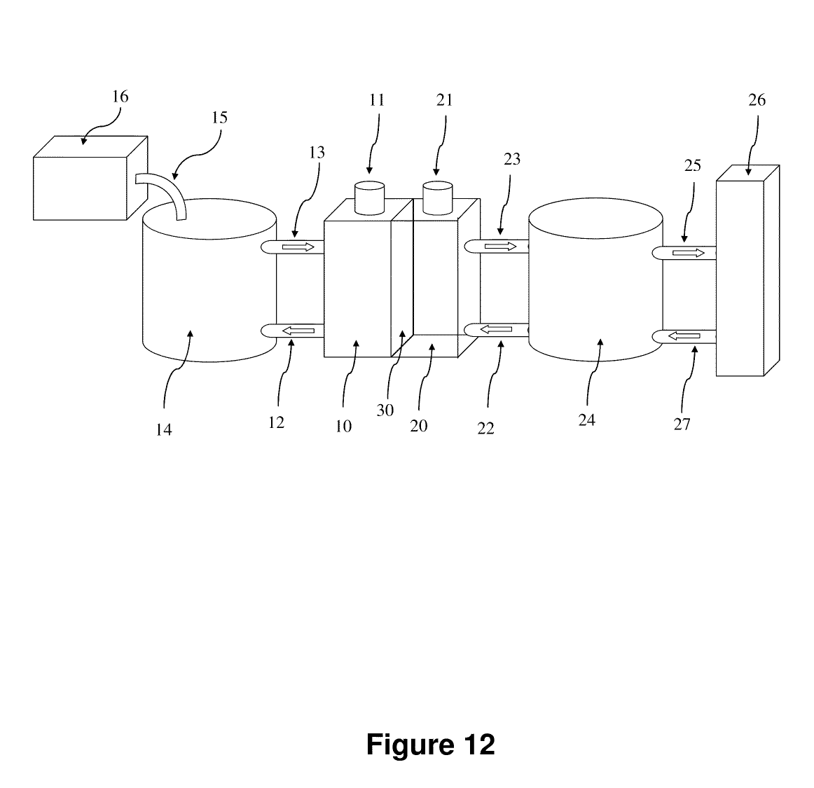

FIG. 12 provides a schematic of a flow cell design compatible with the methods and devices of the present invention. The flow cell comprises a liquid anode 10 and a cathode 20 connected by a separator membrane 30. The liquid anode 10 is connected by filling 13 and emptying 12 lines to a liquid anode reservoir 14. Spent liquid anode material is regenerated in the liquid anode reservoir 14 by a liquid anode regeneration tank 16 which is connect to the liquid anode reservoir 14 by a refill line 15. The cathode 20 is connected by filling 22 and emptying 23 lines to a cathode reservoir 24. Spent cathode material is regenerated in the cathode reservoir 24 by a cathode regeneration tank 26 which is connect to the cathode reservoir 24 by an emptying line 25 and a refill line 27. The flow cell may be discharged by connection to the negative pole 11 and positive pole 21. Alternatively, the flow cell can be electrically charged using a battery charger attached to the positive pole 21 and negative pole 11.

### STATEMENTS REGARDING INCORPORATION BY REFERENCE AND VARIATIONS

Each reference cited herein is hereby incorporated by reference in its entirety. However, if any inconsistency arises between a cited reference and the present disclosure, the present disclosure takes precedent. Some references provided herein are incorporated by reference to provide details concerning the state of the art prior to the filing of this application, other references can be cited to provide additional or alternative device elements, additional or alternative materials, additional or alternative methods of analysis or applications of the invention. Patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the invention has been specifically disclosed by preferred embodiments, exemplary embodiments and optional features, modification and variation of the concepts herein disclosed can be resorted to by those skilled in the art, and that such modifications and variations are considered to be within the scope of this invention as defined by the appended claims. The specific embodiments provided herein are examples of useful embodiments of the invention and it will be apparent to one skilled in the art that the invention can be carried out using a large number of variations of the devices, device components, methods steps set forth in the present description. As will be obvious to one of skill in the art, methods and devices useful for the present methods can include a large number of optional composition and processing elements and steps.

One of ordinary skill in the art will appreciate that device elements, as well as materials, shapes and dimensions of device elements, as well as methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed can be resorted to by those skilled in the art, and that such modifications and variations are considered to be within the scope of this invention.

When a Markush group or other grouping is used herein, all individual members of the group and all combinations and possible subcombinations of the group are intended to be individually included in the disclosure. Every combination of components or materials described or exemplified herein can be used to practice the invention, unless otherwise stated. One of ordinary skill in the art will appreciate that methods, device elements, and materials other than those specifically exemplified can be employed in the practice of the invention without resort to undue experimentation. All art-known functional equivalents, of any such methods, device elements, and materials are intended to be included in this invention. Whenever a range is given in the specification, for example, a temperature range, a frequency range, a time range, or a composition range, all intermediate ranges and all subranges, as well as, all individual values included in the ranges given are intended to be included in the disclosure. Any one or more individual members of a range or group disclosed herein can be excluded from a claim of this invention. The invention illustratively described herein suitably can be practiced in the absence of any element or elements, limitation or limitations which is not specifically disclosed herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. The term “comprising” is intended to be broader than the terms “consisting essentially of” and “consisting of”, however, the term “comprising” as used herein in its broadest sense is intended to encompass the narrower terms “consisting essentially of” and “consisting of.”, thus the term “comprising” can be replaced with “consisting essentially of” to exclude steps that do not materially affect the basic and novel characteristics of the claims and “comprising” can be replaced with “consisting of” to exclude not recited claim elements.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed can be resorted to by those skilled in the art, and that such modifications and variations are considered to be within the scope of this invention as defined by the appended claims.

Although the description herein contains many specifics, these should not be construed as limiting the scope of the invention, but as merely providing illustrations of some of the embodiments of the invention.

What is claimed is:

1. A soluble electrode for use in an electrochemical generator, the soluble electrode comprising:
an electron donor comprising an electron donor metal provided in a solvent, wherein the electron donor metal is an alkali metal, an alkali earth metal, a lanthanide metal or alloy thereof;
an electron acceptor provided in the solvent, wherein the electron acceptor is a polycyclic aromatic hydrocarbon or an organo radical;
wherein at least a portion of the electron donor comprising an electron donor metal is dissolved in the solvent, thereby generating electron donor metal ions and solvated electrons in the solvent.

2. The soluble electrode of claim 1, wherein the electron donor metal is lithium, sodium, potassium, rubidium, magnesium, calcium, aluminum, zinc, carbon, silicon, germanium, lanthanum, europium, strontium or alloy thereof.

3. The soluble electrode of claim 1, wherein the electron donor metal is a metal other than lithium.

4. The soluble electrode of claim 1, wherein the electron donor is a metal hydride, a metal aluminohydride, a metal borohydride, a metal aluminoborohydride or a metal polymer.

5. The soluble electrode of claim 1, wherein the polycyclic aromatic hydrocarbon is Azulene, Naphthalene, 1-Methylnaphthalene, Acenaphthene, Acenaphthylene, Anthracene, Fluorene, Phenalene, Phenanthrene, Benzo[a]anthracene, Benzo[a]phenanthrene, Chrysene, Fluoranthene, Pyrene, Tetracene, Triphenylene Anthanthrene, Benzopyrene, Benzo[a]pyrene, Benzo[e]fluoranthene, Benzo[ghi]perylene, Benzo[j]fluoranthene, Benzo[k]fluoranthene, Corannulene, Coronene, Dicoronylene, Helicene, Heptacene, Hexacene, Ovalene, Pentacene, Picene Perylene, or Tetraphenylene.

6. The soluble electrode of claim 1, wherein the solvent is water, tetrahydrofuran, hexane, ethylene carbonate, propylene carbonate, benzene, carbon disulfide, carbon tetrachloride, diethyl ether, ethanol, chloroform, ether, dimethyl ether, benzene, propanol, acetic acid, alcohols, isobutylacetate, n-butyric acid, ethyl acetate, N-methylpyrrolidone, N,N-dimethyl formiate, ethylamine, isopropyl amine, hexamethylphosphotriamide, dimethyl sulfoxide, tetralkylurea, triphenylphosphine oxide or mixture thereof.

7. The soluble electrode of claim 1 further comprising a current collector provided in contact with the solvent.

8. The soluble electrode of claim 7, wherein the current collector comprises porous carbon, a nickel metal grid, a nickel metal mesh, a nickel metal foam, a copper metal grid, a copper metal mesh, a copper metal foam, a titanium metal grid, a titanium metal mesh, a titanium metal foam, a molybdenum metal grid, a molybdenum metal mesh, or a molybdenum metal foam.

9. The soluble electrode of claim 1, wherein the concentration of the electron donor metal ions in the solvent is greater than about 0.1 M.

10. The soluble electrode of claim 1, wherein the concentration of the electron donor metal ions in the solvent is selected over the range of about 0.1 M to about 10 M.

11. The soluble electrode of claim 1, wherein the concentration of the electron acceptor in the solvent is selected over the range of about 0.1 M to about 15 M.

12. The soluble electrode of claim 1, wherein the organo radical reacts via a charge transfer, partial electron transfer, or full electron transfer reaction with the electron donor metal to form an organometallic reagent.

13. The soluble electrode of claim 1, wherein the organo radical is an alkyl radical, an allyl radical, an amino radical, an imido radical or a phosphino radical.

14. The soluble electrode of claim 1, wherein the organo radical is a butyl radial or an acetyl radical.

15. The soluble electrode of claim 1 further comprising a source of the electron donor metal, the electron acceptor or the solvent operationally connected to the solvent.

16. A soluble electrode for use in an electrochemical generator, the soluble electrode comprising:
an electron donor comprising an electron donor metal provided in a solvent, wherein the electron donor metal is an alkali metal, an alkali earth metal, a lanthanide metal or alloy thereof;
an electron acceptor provided in the solvent, wherein the electron acceptor is a polycyclic aromatic hydrocarbon or an organo radical;
a supporting electrolyte comprising a metal at least partially dissolved in the solvent;
wherein at least a portion of the electron donor comprising an electron donor metal is dissolved in the solvent, thereby generating electron donor metal ions and solvated electrons in the solvent.

17. The soluble electrode of claim 16, wherein the supporting electrolyte comprises:
MXₙ, MO_{q}, MY_{q}, or M(R)ₙ; wherein
M is a metal;
X is —F, —Cl, —Br, or —I;
Y is —S, —Se, or —Te;
R is a group corresponding to a carboxylic group, alcohoate, alkoxide, ether oxide, acetate, formate, or carbonate;
n is 1, 2, or 3; and
q is greater than 0.3 and less than 3.

18. An electrochemical generator comprising:
a negative soluble electrode comprising:
an electron donor comprising an electron donor metal provided in a first solvent, wherein the electron donor metal is an alkali metal, an alkali earth metal, a lanthanide metal or alloy thereof;
an electron acceptor provided in the first solvent, wherein the electron acceptor is a polycyclic aromatic hydrocarbon or an organo radical;
wherein at least a portion of the electron donor comprising an electron donor metal is dissolved in the first solvent, thereby generating electron donor metal ions and solvated electrons in the first solvent;
a positive electrode comprising an active positive electrode material; and
a separator provided between the negative soluble electrode and the positive electrode, wherein the separator is non-liquid and conducts the electron donor metal ions as a charge carrier in the electrochemical generator.

19. The electrochemical generator of claim 18, wherein the electron donor metal is lithium, sodium, potassium, rubidium, magnesium, calcium, aluminum, zinc, carbon, silicon, germanium, lanthanum, europium, strontium or alloy thereof.

20. The electrochemical generator of claim 18, wherein the electron donor metal is a metal other than lithium.

21. The electrochemical generator of claim 18, wherein the electron donor is a metal hydride, a metal aluminohydride, a metal borohydride, a metal aluminoborohydride or a metal polymer.

22. The electrochemical generator of claim 18, wherein the polycyclic aromatic hydrocarbon is Azulene, Naphthalene, 1-Methylnaphthalene, Acenaphthene, Acenaphthylene, Anthracene, Fluorene, Phenalene, Phenanthrene, Benzo[a]anthracene, Benzo[a]phenanthrene, Chrysene, Fluoranthene, Pyrene, Tetracene, Triphenylene Anthanthrene, Benzopyrene, Benzo[a]pyrene, Benzo[e]fluoranthene, Benzo[ghi]perylene, Benzo[j]fluoranthene, Benzo[k]fluoranthene, Corannulene, Coronene, Dicoronylene, Helicene, Heptacene, Hexacene, Ovalene, Pentacene, Picene Perylene, or Tetraphenylene.

23. The electrochemical generator of claim 18, wherein the first solvent is water, tetrahydrofuran, hexane, ethylene carbonate, propylene carbonate, benzene, carbon disulfide, carbon tetrachloride, diethyl ether, ethanol, chloroform, ether, benzene, propanol, acetic acid, alcohols, isobutylacetate, n-butyric acid, ethyl acetate, N-methylpyrrolidone, N,N-dimethyl formiate, ethylamine, isopropyl amine, hexamethylphosphotriamide, dimethyl sulfoxide, tetralkylurea, triphenylphosphine oxide or mixture thereof.

24. The electrochemical generator of claim 18, wherein the organo radical reacts via a charge transfer, partial electron transfer, or full electron transfer reaction with the electron donor metal to form an organometallic reagent.

25. The electrochemical generator of claim 18, wherein the organo radical is an alkyl radical, an allyl radical, an amino radical, an imido radical or a phosphino radical.

26. The electrochemical generator of claim 18, wherein the organo radical is a butyl radial or an acetyl radical.

27. The electrochemical generator of claim 18, wherein the separator conducts the electron donor metal ions between the soluble negative electrode and the positive electrode.

28. The electrochemical generator of claim 18, wherein the separator is an anion conductor, a cation conductor or a cation and anion mixed conductor.

29. The electrochemical generator of claim 18, wherein an electronic conductivity of the separator is less than about 10⁻¹⁵ Siemens cm⁻¹.

30. The electrochemical generator of claim 18, wherein the separator is impermeable to the first solvent of the negative soluble electrode.

31. The electrochemical generator of claim 18, wherein the separator has a thickness selected over the range of about 50 μm to about 10 mm.

32. The electrochemical generator of claim 18, wherein the separator has a thickness selected over the range of about 100 μm to about 200 μm.

33. The electrochemical generator of claim 18, wherein the separator is a ceramic, a glass, a polymer, a gel, or combination thereof.

34. The electrochemical generator of claim 18, wherein the separator comprises an organic polymer, the electron donor metal, an oxide glass, an oxynitiride glass, a sulfide glass, an oxysulfide glass, a thionitril glass, a metal halide doped glass, a crystalline ceramic electrolyte, a perovskite, a nasicon type phosphate, a lisicon type oxide, a metal halide, a metal nitride, a metal phosphide, a metal sulfide, a metal sulfate, a silicate, an aluminosilicate or a boron phosphate.

35. The electrochemical generator of claim 18, wherein the active positive electrode material of the positive electrode is reduced by the electron donor metal ions upon discharge of the electrochemical generator.

36. The electrochemical generator of claim 18, wherein the active positive electrode material is a fluoroorganic material, a fluoropolymer, SOCl₂, SO₂, SO₂Cl₂, M¹Xₚ, H₂O, O₂, MnO₂, CFₓ, NiOOH, Ag₂O, AgO, FeS₂, CuO, AgV₂O_{5.5}, H₂O₂, M¹M²_{y}(PO₄)_{z} or M¹M²_{y}Oₓ; wherein
M¹ is the electron donor metal;
M² is a transition metal or combination of transition metals;
X is —F, —Cl, —Br, —I or mixture thereof;
p is greater than or equal to 3 and less than or equal to 6;
y is greater than 0 and less than or equal to 2;
x is greater than or equal to 1 and less than or equal to 4; and
z is greater than or equal to 1 and less than or equal to 3.

37. An electrochemical generator comprising:
a negative soluble electrode comprising:
an electron donor comprising an electron donor metal provided in a first solvent, wherein the electron donor metal is an alkali metal, an alkali earth metal, a lanthanide metal or alloy thereof;
an electron acceptor provided in the first solvent; wherein the electron acceptor is a polycyclic aromatic hydrocarbon or an organo radical;
a first supporting electrolyte comprising a metal at least partially dissolved in the first solvent;
wherein at least a portion of the electron donor comprising an electron donor metal is dissolved in the first solvent, thereby generating electron donor metal ions and solvated electrons in the first solvent;
a positive electrode comprising:
an active positive electrode material provided in contact with a second solvent;
a second supporting electrolyte comprising a metal at least partially dissolved in the second solvent; and
a separator provided between the negative soluble electrode and the positive electrode, wherein the separator is non-liquid and conducts the electron donor metal ions as a charge carrier in the electrochemical generator.

38. The electrochemical generator of claim 37, wherein the first supporting electrolyte and the second supporting electrolyte each individually comprises MXₙ, MO_{q}, MY_{q}, or M(R)ₙ; wherein
M is a metal;
X is —F, —Cl, —Br, or —I;
Y is —S, —Se, or —Te;
R is a group corresponding to a carboxylic group, alcohoate, alkoxide, ether oxide, acetate, formate, or carbonate;
n is 1, 2, or 3; and
q is greater than 0.3 and less than 3.

39. The electrochemical generator of claim 37, wherein the second solvent is water.

40. The electrochemical generator of claim 37, wherein the positive electrode further comprises a current collector provided in contact with the second solvent.

41. The electrochemical generator of claim 40, wherein the current collector comprises porous carbon, a nickel metal grid, a nickel metal mesh, a nickel metal foam, a copper metal grid, a copper metal mesh, a copper metal foam, a titanium metal grid, a titanium metal mesh, a titanium metal foam, a molybdenum metal grid, a molybdenum metal mesh, or a molybdenum metal foam.

42. The electrochemical generator of claim 37, wherein the soluble negative electrode further comprises a current collector provided in contact with the first solvent.

43. The electrochemical generator of claim 42, wherein the current collector comprises porous carbon, a nickel metal grid, a nickel metal mesh, a nickel metal foam, a copper metal grid, a copper metal mesh, a copper metal foam, a titanium metal grid, a titanium metal mesh, a titanium metal foam, a molybdenum metal grid, a molybdenum metal mesh, or a molybdenum metal foam.

44. The electrochemical generator of claim 18 further comprising a source of the electron donor, the electron acceptor or the first solvent operationally connected to the first solvent.

45. The electrochemical generator of claim 37 further comprising a source of the active positive electrode material, the supporting electrolyte or the second solvent operationally connected to the second solvent.

46. The electrochemical generator of claim 18, wherein the electron donor metal is lithium, the electron acceptor is naphthalene, the first solvent is tetrahydrofuran, the separator is a ceramic and the active positive electrode material is O₂.

47. The electrochemical generator of claim 18, wherein the electron donor metal is lithium, the electron acceptor is biphenyl, the first solvent is tetrahydrofuran, the separator is a ceramic and the active positive electrode material is MnO₂.

48. The electrochemical generator of claim 18, wherein the electrochemical generator is an electrochemical cell.

49. The electrochemical generator of claim 48, wherein the electrochemical cell is a primary cell.

50. The electrochemical generator of claim 48, wherein the electrochemical cell is a secondary cell.

51. The electrochemical generator of claim 37, wherein the electrochemical generator is a flow cell.

52. The electrochemical generator of claim 37, wherein the electrochemical generator is a fuel cell.

53. A method of discharging an electrochemical generator, the method comprising:
providing an electrochemical generator, the generator comprising:
a negative soluble electrode comprising:
an electron donor comprising an electron donor metal provided in a first solvent, wherein the electron donor metal is an alkali metal, an alkali earth metal, a lanthanide metal or alloy thereof;
an electron acceptor provided in the first solvent; wherein the electron acceptor is a polycyclic aromatic hydrocarbon or an organo radical;
a first supporting electrolyte comprising a metal at least partially dissolved in the first solvent;
wherein at least a portion of the electron donor comprising an electron donor metal is dissolved in the first solvent, thereby generating electron donor metal ions and solvated electrons in the first solvent;
a positive electrode comprising:
an active positive electrode material provided in contact with a second solvent;
a second supporting electrolyte comprising a metal at least partially dissolved in the second solvent;
a separator provided between the negative soluble electrode and the positive electrode, wherein the separator is non-liquid and conducts the electron donor metal ions as a charge carrier in the electrochemical generator; and
discharging the electrochemical generator.

54. A method of charging an electrochemical generator, the method comprising:
providing an electrochemical generator, the generator comprising:
a negative soluble electrode comprising:
an electron donor comprising an electron donor metal provided in a first solvent, wherein the electron donor metal is an alkali metal, an alkali earth metal, a lanthanide metal or alloy thereof;
an electron acceptor provided in the first solvent; wherein the electron acceptor is a polycyclic aromatic hydrocarbon or an organo radical;
a first supporting electrolyte comprising a metal at least partially dissolved in the first solvent;
wherein at least a portion of the electron donor comprising an electron donor metal is dissolved in the first solvent, thereby generating electron donor metal ions and solvated electrons in the first solvent;
a positive electrode comprising:
an active positive electrode material provided in contact with a second solvent;
a second supporting electrolyte comprising a metal at least partially dissolved in the second solvent;
a separator provided between the negative soluble electrode and the positive electrode, wherein the separator is non-liquid and conducts the electron donor metal ions as a charge carrier in the electrochemical generator;
selecting a charging voltage and/or current according to a state of health of the electrochemical generator; and
providing the selected voltage and/or current to the electrodes of the electrochemical generator to charge the electrochemical generator.

55. The method of claim 54, wherein the voltage and/or current provided to the electrochemical generator is preselected according to the number of charge/discharges cycles the electrochemical generator has experienced.

56. A method of charging an electrochemical generator, the method comprising:
providing an electrochemical generator, the generator comprising:
a negative soluble electrode comprising:
an electron donor comprising an electron donor metal provided in a first solvent, wherein the electron donor metal is an alkali metal, an alkali earth metal, a lanthanide metal or alloy thereof;
an electron acceptor provided in the first solvent; wherein the electron acceptor is a polycyclic aromatic hydrocarbon or an organo radical;
a first supporting electrolyte comprising a metal at least partially dissolved in the first solvent;
wherein at least a portion of the electron donor comprising an electron donor metal is dissolved in the first solvent, thereby generating electron donor metal ions and solvated electrons in the first solvent;
a positive electrode comprising:
an active positive electrode material provided in contact with a second solvent;
a second supporting electrolyte comprising a metal at least partially dissolved in the second solvent;
a separator provided between the negative soluble electrode and the positive electrode, wherein the separator is non-liquid and conducts the electron donor metal ions as a charge carrier in the electrochemical generator;
removing substantially all of the electron donor metal, electron acceptor and first solvent from the soluble negative electrode; and
providing electron donor metal, electron acceptor and first solvent to the soluble negative electrode.
